(19) United States
(12) Patent Application Publication
(10) Pub. No.: US 2008/0200499 A1
(43) Pub. Date: Aug. 21, 2008

(54) Selective Insecticides and/or Acaricides Based on Substituted Cyclic Dicarbonyl Compounds and Safeners

(76) Inventors: Reiner Fischer, Monheim (DE); Udo Reckmann, Koln (DE); Chris Rosinger, Hofheim (DE); Erich Sanwald, Kiel (DE); Christian Arnold, Langenfeld (DE)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/632,501

(22) PCT Filed: Jul. 18, 2005
(86) PCT No.: PCT/EP2005/007790

§ 371 Date: Jan. 24, 2008

(30) Foreign Application Priority Data
Jul. 20, 2004 (EP) 10 2004 035 131.7

(51) Int. Cl. A01N 43/42; A01P 7/02; A01P 7/04; A01N 43/36; A01N 43/56; A01N 43/38; A01N 43/10; A01N 43/08; A01N 41/06

(52) U.S. Cl. 514/307; 514/412; 514/425; 514/404; 514/445; 514/473; 514/603; 514/311

(57) ABSTRACT

The present invention relates to the use of selective insecticidal and/or acaricidal compositions, characterized in that they comprise an effective amount of an active compound combination comprising
(a) at least one substituted cyclic dicarbonyl compound of the formula (I)

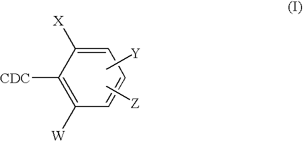

in which W, X, Y and Z are as defined in the description and CDC is one of the dicarbonyl radicals mentioned in the description,
   and
(b) at least one crop plant compatibility-improving compound from the group of compounds given in the description.
   for controlling insects and/or arachnids, and also to a method for controlling insects and/or arachnids using the compositions.

The invention relates to the use of selective insecticidal and/or acaricidal active compound combinations comprising firstly substituted cyclic dicarbonyl compounds and secondly at least one crop plant compatibility-improving compound, which combinations can be used for the selective control of insects and/or spider mites in various crops of useful plants.

It is known that 4-chloro- und 4-nitro-4-phenyl-pyrazolyl-3,5-diones (WO 99/20610) have herbicidal action and that 3-halo- and 3-nitro-3-phenyl-substituted pyrrolidine-2,4-diones and 4-oxofuran-2-ones (JP-A 12 086 628) have acaricidal and insecticidal action, and also herbicidal, acaricidal and insecticidal action (WO 03/029 213, DE-A 103 01805, WO 03/045 957, WO 2004/069 841.).

Also known are 2-chloro-2-phenylcyclopentane-1,3-diones and 2-chloro-2-phenylcyclohexane-1,3-diones from WO 2004/037 749.

Likewise known are 4-chloro-4-phenylpyrazolidine-3,5-diones having herbicidal and insecticidal/acaricidal action from WO 2005/016 933.

Moreover, selective herbicides based on substituted cyclic dicarbonyl compounds and safeners have been described (WO 2004/064 520).

However, the compatibility of these compounds in particular with monocotyledonous crop plants is not under all conditions entirely satisfactory.

Surprisingly, it has now been found that certain substituted cyclic dicarbonyl compounds when used together with the crop plant compatibility-improving compounds (safeners/antidotes) described below, prevent damage to crop plants extremely well and can be used particularly advantageously as broad-spectrum combination preparations for the selective control of insects even in crop of monocotyledonous useful plants, such as, for example, in cereals.

The invention provides the use of selective insecticidal and/or acaricidal compositions comprising an effective amount of an active compound combination comprising, as components
(a) at least one substituted cyclic dicarbonyl compound of the formula (I)

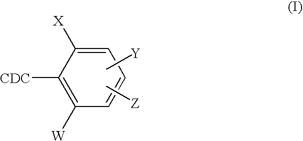

in which
W and Z independently of one another represent hydrogen, halogen, alkyl, alkenyl, alkynyl, alkoxy, alkenyloxy, haloalkyl, haloalkoxy, haloalkenyloxy, nitro or cyano,
X represents halogen, alkyl, alkenyl, alkynyl, alkoxy, alkenyloxy, alkylthio, alkylsulphinyl, alkylsulphonyl, haloalkyl, haloalkoxy, haloalkenyloxy, nitro or cyano,
Y represents hydrogen, halogen, alkyl, haloalkyl, haloalkoxy, nitro, cyano or represents optionally substituted phenyl or hetaryl,
CDC represents one of the groups

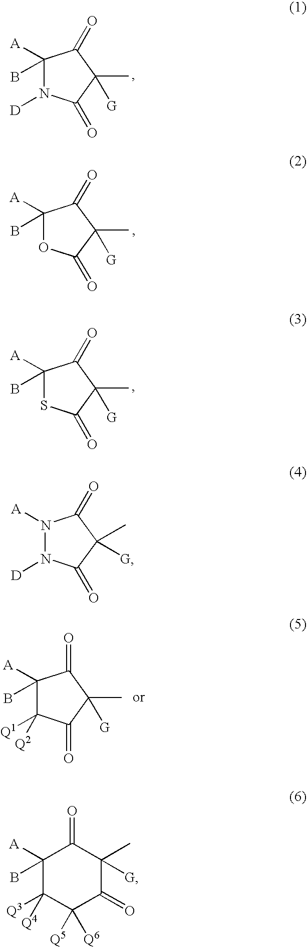

in which
A represents hydrogen, in each case optionally halogen-substituted alkyl, alkenyl; alkoxyalkyl, alkylthioalkyl, saturated or unsaturated, optionally substituted cycloalkyl in which optionally at least one ring atom is replaced by a heteroatom, or in each case optionally halogen-, alkyl-, haloalkyl-, alkoxy-, haloalkoxy-, cyano- or nitro-substituted aryl, arylalkyl or hetaryl,
B represents hydrogen, alkyl or alkoxyalkyl, or
A and B together with the carbon atom to which they are attached represent a saturated or unsaturated, unsubstituted or substituted cycle which optionally contains at least one heteroatom,
D represents hydrogen or an optionally substituted radical from the group consisting of alkyl, alkenyl, alkynyl, alkoxyalkyl, saturated or unsaturated cycloalkyl in which optionally one or more ring members are replaced by heteroatoms, arylalkyl, aryl, hetarylalkyl or hetaryl or
A and D together with the atoms to which they are attached represent a saturated or unsaturated cycle which is unsubstituted or substituted in the A,D moiety and optionally contains at least one heteroatom, or
A and Q¹ together represent alkanediyl or alkenediyl optionally substituted by hydroxyl or by in each case optionally substituted alkyl, alkoxy, alkylthio, cycloalkyl, benzyloxy or aryl, or
Q¹ represents hydrogen or alkyl,
Q², Q⁴, Q⁵ and Q⁶ independently of one another represent hydrogen or alkyl,
Q³ represents hydrogen, alkyl, alkoxyalkyl, alkylthioalkyl, optionally; substituted cycloalkyl (in which optionally one methylene group is replaced by oxygen or sulphur) or optionally substituted phenyl, or
Q³ and Q⁴ together with the carbon atom to which they are attached represent a saturated or unsaturated, unsubstituted or substituted cycle which optionally contains a heteroatom,
G represents halogen or nitro,
including all isomeric forms,
   and
(b) at least one crop plant compatibility-improving compound from the following group of compounds:
   4-dichloroacetyl-1-oxa-4-azaspiro[4.5]decane (AD-67, MON-4660), 1-dichloroacetyl-hexa-hydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinolin-8-oxyacetate (cloquintocet-mexyl—cf. also related compounds in EP-A-86750, EP-A-94349, EP-A-191736, EP-A-492366), 3-(2-chlorobenzyl)-1-(1-methyl-1-phenylethyl)urea (cumyluron), α-(cyanomethoximino)-phenylacetonitrile (cyometrinil), 2,4-dichlorophenoxyacetic acid (2,4-D), 4-(2,4-dichlorophenoxy)butyric acid (2,4 DB), 1-(1-methyl-1-phenylethyl)3-(4-methylphenyl)urea (daimuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl—cf. also related compounds in EP-A-174562 and EP-A-346620), phenylmethyl 2-chloro-4-trifluormethylthiazole-5-carboxylate (flurazole), 4-chloro-N-(1,3 dioxolan-2-ylmethoxy)-α-(trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl—cf. also related compounds in WO-A-95/07897), 1-(ethoxycarbonyl)ethyl-3,6-dichloro-2-methoxybenzoate (lactidichlor), (4-chloro-o-tolyloxy)acetic acid (MCPA), 2-(4-chloro-tolyloxy)propionic acid. (mecoprop), diethyl 1-(2,4-dichlorophenyl)-4,5-dihydro-5-methyl-1H-pyrazole-3,5-dicarboxylate (mefenpyr-diethyl—cf. also related compounds in WO-A-91107874), 2-dichloromethyl-2-methyl-1,3-dioxolane (MG-191), 2-propenyl-1-oxa-4-azaspiro[4.5]decane, 4-carbodithioate (MG-838), 1,8-naphthalic anhydride, α-(1,3-dioxolan-2-yl-methoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), 4-(4-chloro-o-tolyl)butyric acid, 4-(4-chlorophenoxyibutyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate (cf. also related compounds in EP-A-269806 and EP-A-333131), ethyl 5-(2,4-dichlorobenzyl)-2-isoxazoline-3-carboxylate, ethyl 5-phenyl-2-isoxazoline-3-carboxylate, ethyl 5-(4-fluorophenyl)-5-phenyl-2-isoxazoline-3-carboxylate (cf also related compounds in WO-A-91/08202), 1,3-dimethylbut-1-yl 5-chloroquinolin-8-oxyacetate, 4-allyloxybutyl 5-chloroquinolin-8-oxyacetate, 1-allyl-oxyprop-2-yl 5-chloroquinolin-8-oxyacetate, methyl 5-chloroquinoxalin-8-oxyacetate, ethyl 5-chloroquinolin-8-oxyacetate, allyl 5-chloroquinoxalin-8-oxyacetate, 2-oxoprop-1-yl 5-chloroquinolin-8-oxyacetate, diethyl 5-chloroquinolin-8-oxymalonate, diallyl 5-chloroquinoxalin-8-oxymalonate, diethyl 5-chloroquinolin-8-oxymalonate (cf. also related compounds in EP-A-582198), 4-carboxy-chroman-4-ylacetic acid (AC-304415, cf. EP-A-613618), 4-chlorophenoxyacetic acid, 3,3′-dimethylmeihoxybenzophenone, 1-bromochloromethylsulphonylbenzene, 1-[4-(N-2-methoxybenzoylsulphamoyl)phenyl]-3-methylurea (alias N-(2-methoxybenzoyl)-4-[(methylaminocarbonyl)amino]benzenesulphonamide), 1-[4-N-2-n ethoxybenzoylsulphamoyl)phenyl]-3,3-dimethylurea, 1-[4-(N-4,5-dimethylbenzoylsulphamoyl)phenyl]-3-methylurea, 1-[4-(N-naphthylsulphamoyl)-phenyl]-3,3-dimethylurea, N-(2-methoxy-5-methylbenzoyl)-4-(cyclopropylaminocarbonyl)-benzenesulphonamide,
   and/or one of the following compounds (defined by general formulae)
   of the general formula (IIa)

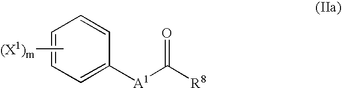

or of the general formula (IIb)

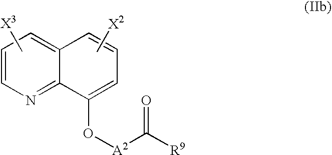

or of the formula (IIc)

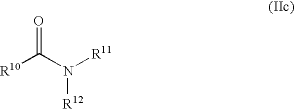

where
m represents a number 0, 1, 2, 3, 4 or 5,
A¹ represents one of the divalent heterocyclic groups outlined hereinbelow,

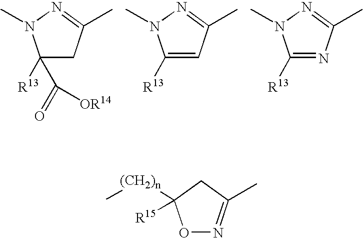

n represents a number 0, 1, 2, 3, 4 or 5,
A² represents alkanediyl having 1 or 2 carbon atoms which is optionally substituted by C₁-C₄-alkyl and/or C₁-C₄-alkoxycarbonyl and/or C₁-C₄-alkenyloxy-carbonyl,
R⁸ represents hydroxyl, mercapto, amino, C₁-C₆-alkoxy, C₁-C₆-alkylthio, C₁-C₆-alkylamino or di-(C₁-C₄-alkyl)amino,
R⁹ represents hydroxyl, mercapto, amino, C₁-C₇-alkoxy, C₁-C₆-alkenyloxy, C₁-C₆-alkenyloxy-C₁-C₆-alkoxy, C₁-C₆-alkylthio, C₁-C₆-alkylamino or di-C₁-C₄-alkyl)amino,
R¹⁰ represents C₁-C₄-alkyl which is optionally substituted in each case by fluorine, chlorine and/or bromine,
R¹¹ represents hydrogen, or represents C₁-C₆-alkyl, C₂-C₆-alkenyl or C₂-C₆-alkynyl, C₁-C₄-alkoxy-C₁-C₄-alkyl, dioxolanyl-C₁-C₄-alkyl; furyl, furyl-C₁-C₄-alkyl, thienyl, thiazolyl, piperidinyl, each of which is optionally substituted by fluorine, chlorine and/or bromine, or represents phenyl which is optionally substituted by fluorine, chlorine and/or bromine or C₁-C₄-alkyl,
R¹² represents hydrogen, or represents C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, each of which is optionally substituted by fluorine, chlorine and/or bromine, or represents phenyl which is optionally substituted by fluorine, chlorine and/or bromine or C₁-C₄-alkyl, or R¹¹ and R¹² together represent C₃-C₆-alkanediyl or C₂-C₅-oxaalkanediyl, each of which is optionally substituted by C₁-C₄-alkyl, phenyl, furyl, a fused benzene ring or by two substituents which, together with the C atom to which they are bonded, form a 5- or 6-membered carbocycle,
R¹³ represents hydrogen, cyano, halogen, or represents C₁-C₄-alkyl, C₃-C₆-cycloalkyl or phenyl, each of which is optionally substituted by fluorine, chlorine and/or bromine,
R¹⁴ represents hydrogen, or represents C₁-C₆-alkyl, C₃-C₆-cycloalkyl or tri(C₁-C₄-alkyl)silyl, optionally substituted by hydroxyl, cyano, halogen or C₁-C₄-alkoxy,
R¹⁵ represents hydrogen, cyano, halogen, or represents C₁-C₄-alkyl, C₃-C₆-cycloalkyl or phenyl, each of which is optionally substituted by fluorine, chlorine and/or bromine,
X¹ represents nitro, cyano, halogen, C₁-C₄-alkyl, C₁-C₄-haloalkyl; C₁-C₄-alkoxy or C₁-C₄-haloalkoxy,
X² represents hydrogen, cyano, nitro, halogen, C₁-C₄-alkyl, C₁-C₄-haloalkyl, C₁-C₄-alkoxy or C₁-C₄-haloalkoxy,
X³ represents hydrogen, cyano, nitro, halogen, C₁-C₄-alkyl, C₁-C₄-haloalkyl, C₁-C₄-alkoxy or C₁-C₄-haloalkoxy,
   and/or the following compounds (defined by general formulae)
   of the general formula (IId)

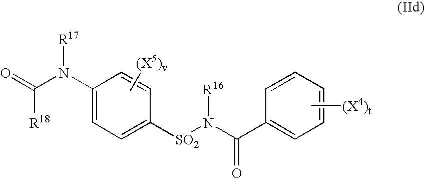

or of the general formula (IIe)

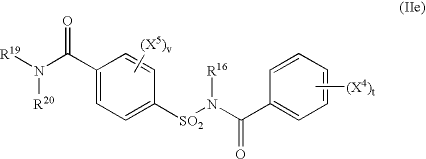

where
t represents a number 0, 1, 2, 3, 4 or 5,
v represents a number 0, 1, 2, 3, 4 or 5,
R¹⁶ represents hydrogen or C₁-C₄-allyl,
R¹⁷ represents hydrogen or C₁-C₄-alkyl,
R¹⁸ represents hydrogen, or represents C₁-C₆-alkyl, C₁-C₆-alkoxy, C₁-C₆-alkylthio, C₁-C₆-alkylamino or di-(C₁-C₄-alkyl)amino, each of which is optionally substituted by cyano, halogen or C₁-C₄-alkoxy, or represents C₃-C₆-cycloalkyl, C₃-C₆-cycloalkyloxy, C₃-C₆-cycloalkylthio or C₃-C₆Cycloalkylamino, each of which is optionally substituted by cyano, halogen or C₁-C₄-alkyl,
R¹⁹ represents hydrogen, or represents C₁-C₆-alkyl which is optionally substituted by cyano, hydroxyl, halogen or C₁-C₄-alkoxy, or represents C₃-C₆-alkenyl or C₃-C₆-alkynyl, each of which is optionally substituted by cyano or halogen, or represents C₃-C₆-cycloalkyl which is optionally substituted by cyano, halogen or C₁-C₄-alkyl,
R²⁰ represents hydrogen, or represents C₁-C₆-alkyl which is optionally substituted by cyano, hydroxyl, halogen or C₁-C₄-alkoxy, or represents C₃-C₆-alkenyl or C₃-C₆-alkynyl, each of which is optionally substituted by cyano or halogen, or represents —C₃-C₆-cycloalkyl which is optionally substituted by cyano, halogen or C₁-C₄-alkyl, or represents phenyl which is optionally substituted by nitro, cyano, halogen, C₁-C₄-alkyl, C₁-C₄-haloalkyl, C₁-C₄-alkoxy or C₁-C₄-haloalkoxy, or together with R¹⁹ represents C₂-C₆-alkanediyl or C₂-C₅-oxaalkanediyl, each of which is optionally substituted by C₁-C₄-alkyl,
X⁴ represents nitro, cyano, carboxyl, carbamoyl, formyl, sulphamoyl, hydroxyl, amino, halogen, C₁-C₄-alkyl, C₁-C₄-haloalkyl, C₁-C₄-alkoxy or C₁-C₄-haloalkoxy, and
X⁵ represents nitro, cyano, carboxyl, carbamoyl, formyl, sulphamoyl, hydroxyl, amino, halogen, C₁-C₄-alkyl, C₁-C₄-haloalkyl, C₁-C₄-alkoxy or C₁-C₄-haloalkoxy
   for controlling insects and/or arachnids.

In the definitions, the hydrocarbon chains, such as in alkyl or alkanediyl, are in each case straight-chain or branched—including in combination with heteroatoms, such as in alkoxy.

Depending inter alia on the nature of the substituents, the compounds of the formula (I) can be present as geometrical and/or optical isomers or isomer mixtures of varying composition which, if appropriate, may be separated in a customary manner. The present invention provides both the pure isomers and the isomer mixtures, and also their use and compositions comprising them. Hereinbelow, for the sake of simplicity, only compounds of the formula (I) are referred to in each case, although what is meant are both the pure compounds and, if appropriate, also mixtures having different proportions of isomeric compounds.

Taking into account the meanings (1) to (6) of the group CDC, the following principal structures (I-1) to (I-6) result:

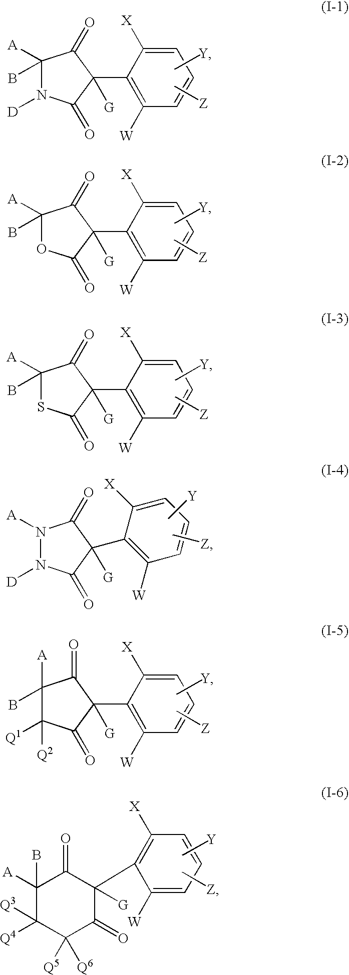

in which
A, B, D, G, Q¹, Q², Q³, Q⁴, Q⁵, Q⁶, W, X, Y and Z are as defined above.

The formula (I) provides a general definition of the substituted cyclic dicarbonyl compounds of the insecticidal and/or acaricidal compositions. Preferred substituents or ranges of the radicals given for the formulae mentioned above and below are illustrated below:
W and Z independently of one another preferably represent hydrogen, halogen, C₁-C₆-alkyl, C₁-C₆-haloalkyl or C₁-C₆-alkoxy,
X preferably represents halogen, C₁-C₆-alkyl, C₂-C₆-alkenyl, C₁-C₆-alkynyl, C₁-C₆-haloalkyl, C₁-C₆-alkoxy, C₃-C₆-alkenyloxy, C₁-C₆-haloalkoxy, C₃-C₆-haloalkenyloxy, nitro or cyano,
Y preferably represents hydrogen, halogen, C₁-C₄-alkyl, C₁-C₂-haloalkyl, C₁-C₂ haloalkoxy, cyano or one of the radicals

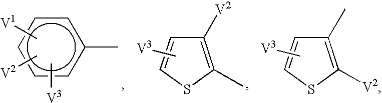

in which
V¹ preferably represents hydrogen, halogen, C₁-C₁₂-alkyl, C₁-C₆-alkoxy, C₁-C₄-haloalkyl, C₁-C₄-haloalkoxy, nitro or cyano,
V² and V³ independently of one another preferably represent hydrogen, halogen, C₁-C₆-alkyl, C₁-C₆-alkoxy, C₁-C₄-haloalkyl or C₁-C₄-haloalkoxy,
CDC preferably represents one of the groups

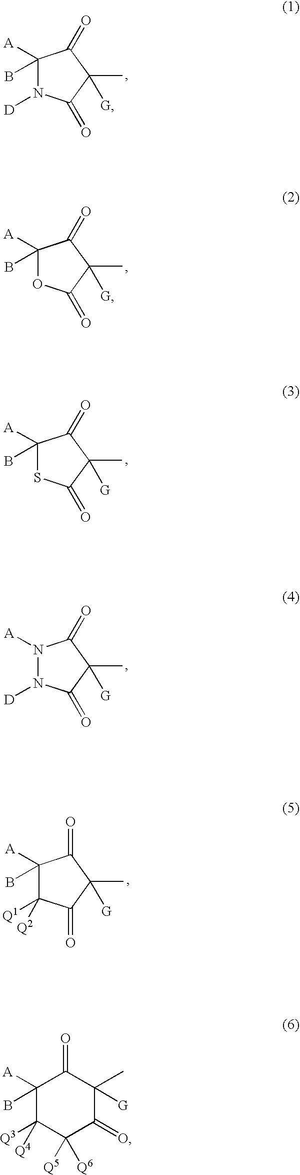

A preferably represents hydrogen or in each case optionally halogen-substituted C₁-C₁₂-alkyl, C₃-C₈-alkenyl, C₁-C₁₀-alkoxy-C₁-C₈-alkyl, C₁-C₁₀-alkylthio-C₁-C₆-alkyl, optionally halogen; C₁-C₆-alkyl- or —C₁-C₆-alkoxy-substituted-C₃-C₈-cycloalkyl in which optionally one or two not directly adjacent ring members are replaced by oxygen and/or sulphur or represents in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or phenyl-C₁-C₆-alkyl,
B preferably represents hydrogen, C₁-C₁₂-alkyl or C₁-C₈-alkoxy-C₁-C₆-alkyl, or
A, B and the carbon atom to which they are attached preferably represent saturated C₃-C₁₀-cycloalkyl or unsaturated C₅-C₁₀-cycloalkyl in which optionally one ring member is replaced by oxygen or sulphur and which are optionally mono- or disubstituted by C₁-C₈-alkyl, C₃-C₁₀-cycloalkyl, C₁-C₈-haloalkyl, C₁-C₈-alkoxy, C₁-C₈-alkylthio, halogen or phenyl, or
A, B and the carbon atom to which they are attached preferably represent C₅-C₆-cycloalkyl which is substituted by an alkylenediyl group which is optionally substituted by C₁-C₄-alkyl and which optionally contains one or two not directly adjacent oxygen and/or sulphur atoms, or by an alkylenedioxyl group or by an alkylenedithioyl group which, together with the carbon atom to which it is attached, forms a further five- to eight-membered ring, or
A, B and the carbon atom- to which they are attached preferably represent C₃-C₈ cycloalkyl or C₅-C₈-cycloalkenyl in which two substituents together with the carbon atoms to which they are attached represent in each case optionally C₁-C₆-alkyl-, C₁-C₆-alkoxy- or halogen-substituted C₂-C₆-alkanediyl, C₂-C₆-alkenediyl or C₄-C₆-alkanedienediyl in which optionally one methylene group is replaced by oxygen or sulphur,
D preferably represents hydrogen, represents in each case optionally halogen-substituted C₁-C₁₂-alkyl, C₃-C₈-alkenyl, C₃-C₈-alkynyl, C₁-C₁₀-alkoxy-C₂-C₈-alkyl optionally halogen-, C₁-C₄-alkyl-, C₁-C₄-alkoxy- or C₁-C₄-haloalkyl-substituted C₃-C₈-cycloalkyl in which optionally lone ring member is replaced by oxygen or sulphur or in each case optionally halogen-, C₁-C₆-alkyl-, C₁-C₆-haloalkyl-, C₁-C₆-alkoxy-; C₁-C₆-haloalkoxy-, cyano- or nitro-substituted phenyl or phenyl-C₁-C₆-alkyl,
A and D together preferably represent in each case optionally substituted C₃-C₆-alkanediyl or C₃-C₆-alkenediyl in which optionally one methylene group is replaced by a carbonyl group, oxygen or sulphur
   suitable substituents being in each case:
   halogen, hydroxyl, mercapto or in each case optionally halogen-substituted C₁-C₁₀-alkyl or C₁-C₆-alkoxy, or a further C₃-C₆-alkanediyl grouping, C₃-C₆-alkenediyl grouping or a butadienyl grouping which is optionally substituted by C₁-C₆-alkyl or in which optionally two adjacent substituents together with the carbon atoms to which they are attached form a further saturated or unsaturated cycle having 5 or 6 ring atoms (in the case of the compound of the formula (I-1), A and D together with the atoms to which they are attached then preferably represent, for example, the groups AD-1 to AD-10 mentioned below) which may contain oxygen or sulphur,
A and Q¹ together preferably represent C₃-C₆-alkanediyl or C₄-C₆-alkenediyl, each of which is optionally mono- or disubstituted by identical or different substituents from the group consisting of halogen, of C₁-C₁₀-alkyl, C₁-C₆-alkoky, C₁-C₆-alkylthio, C₃-C₇-cycloalkyl, each of which is optionally mono- to trisubstituted by identical or different halogen, and of benzyloxy and phenyl, each of which is optionally mono- to trisubstituted by identical or different substituents from the group consisting of halogen, C₁-C₆-alkyl and C₁-C₆-alkoxy, which C₃-C₆-alkanediyl or C₄-C₆-alkenediyl is furthermore bridged by a C₁-C₂-alkanediyl group or by an oxygen atom, or
Q¹ preferably represents hydrogen or C₁-C₄-alkyl,
Q², Q⁴, Q⁵ and Q⁶ independently of one another preferably represent hydrogen or C₁-C₄-alkyl,
Q³ preferably represents hydrogen, C₁-C₆-alkyl, C₁-C₆-alkoxy-C₁-C₂-alkyl, C₁-C₆-alkylthio-C₁-C₂-alkyl, optionally halogen-, C₁-C₄-alkyl- or C₁-C₄-alkoxy-substituted C₃-C₈-cycloalkyl in which optionally one methylene group is replaced by oxygen or sulphur or represents optionally halogen-, C₁-C₄-alkyl-, C₁-C₄-alkoxy-, C₁-C₂-haloalkyl-, C₁-C₂-haloalkoxy-, cyano- or nitro-substituted phenyl, or
Q³ and Q⁴ together with the carbon atom to which they are attached preferably represent an optionally C₁-C₄-alkyl-, C₁-C₄-alkoxy- or C₁-C₂-haloalkyl-substituted C₃-C₇-ring in which optionally one ring member is replaced by oxygen or sulphur,
G preferably represents chlorine, bromine or nitro.

In the radical definitions mentioned as being preferred, halogen represents fluorine, chlorine, bromine and iodine, in particular fluorine, chlorine and bromine.
W and Z independently of one another particularly preferably represent hydrogen, chlorine, bromine, C₁-C₃-alkyl or C₁-C₃-alkoxy,
X particularly preferably represents chlorine, bromine, C₁-C₄-alkyl, C₁-C₄-alkoxy, C₁-C₃-haloalkyl, C₁-C₃-haloalkoxy or cyano,
Y particularly preferably represents hydrogen, chlorine, bromine, C₁-C₂-alkyl, trifluoromethyl or represents the radical.

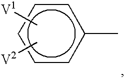

V¹ particularly preferably represents hydrogen, fluorine, chlorine, bromine, C₁-C₆-alkyl, C₁-C₄-alkoxy, C₁-C₂-haloalkyl, C₁-C₂-haloalkoxy, nitro or cyano,
V² particularly preferably represents hydrogen, fluorine, chlorine, bromine, C₁-C₄-alkyl, C₁-C₄-alkoxy, C₁-C₂-haloalkyl or C₁-C₂-haloalkoxy,
CDC particularly preferably represents one of the groups

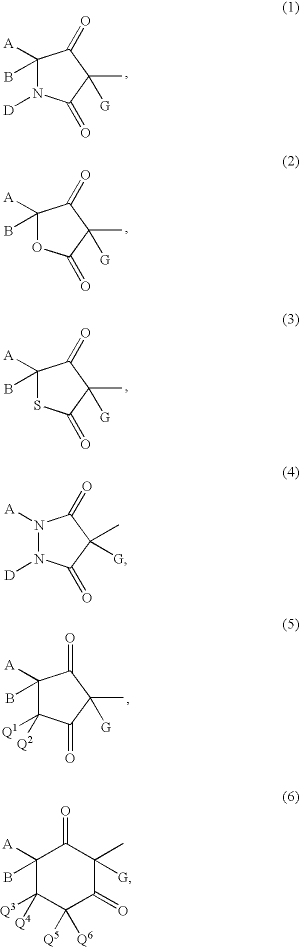

A particularly preferably represents hydrogen, represents C₁-C₆-alkyl, C₁-C₄-alkoxy-C₁-C₂-alkyl, each of which is optionally mono- to trisubstituted by fluorine or chlorine, or represents C₃-C₇-cycloalkyl which is optionally mono- or disubstituted by fluorine, chlorine, C₁-C₂-alkyl or C₁-C₂-alkoxy,
B particularly preferably represents hydrogen or C₁-C₆-alkyl, or
A, B and the carbon atom to which they are attached particularly preferably represent saturated C₃-C₇-cycloalkyl in which optionally one ring member is replaced by oxygen or sulphur and which is optionally monosubstituted by C₁-C₄-alkyl, C₁-C₂-haloalkyl or C₁-C₄-alkoxy, with the proviso that Q³ then particularly preferably represents hydrogen or methyl, or
A, B and the carbon atom to which they are attached particularly preferably represent C₅-C₆-cycloalkyl which is substituted by an alkylenediyl group which optionally contains one or two not directly adjacent oxygen or sulphur atoms and which is optionally substituted by methyl or ethyl, or by an alkylenedioxyl group, which, together with the carbon atom to which it is attached, forms a further five- or six-membered ring, with the proviso that Q³ then particularly preferably represents hydrogen or methyl, or
A, B and the carbon atom to which they are attached particularly preferably represent C₃-C₆-cycloalkyl or C₅-C₆-cycloalkenyl in which two substituents together with the carbon atoms to which they are attached represent C₂-C₄-alkanediyl, C₂-C₄-alkenediyl, where optionally one methylene group is replaced by oxygen, or butadienediyl, each of which is optionally monosubstituted by methyl or methoxy, with the proviso that Q³ then particularly preferably represents hydrogen or methyl,
D particularly preferably represents hydrogen, represents C₁-C₆-alkyl, C₃-C₆-alkenyl, C₁-C₄-alkoxy-C₂-C₃-alkyl, each of which is optionally mono- to trisubstituted by fluorine or chlorine, represents C₃-C₇-cycloalkyl which is optionally monosubstituted by C₁-C₂-alkyl, C₁-C₂-alkoxy or trifluoromethyl and in which optionally one methylene group is replaced by oxygen or sulphur or (but not in the case of the compounds of the formula (I-1)) represents phenyl, pyridyl or benzyl, each of which is optionally mono- or disubstituted by fluorine, chlorine, bromine, C₁-C₄-alkyl, C₁-C₂-haloalkyl, C₁-C₄-alkoxy or C₁-C₂-haloalkoxy, or
A and D together particularly preferably represent optionally substituted C₃-C₅-alkanediyl in which one methylene group may be replaced by oxygen or sulphur, possible substituents being C₁-C₂-alkyl, or
A and D (in the case of the compounds of the formula (I-1)) together with the atoms to which they are attached particularly preferably represent one of the groups AD-1 to AD-10:

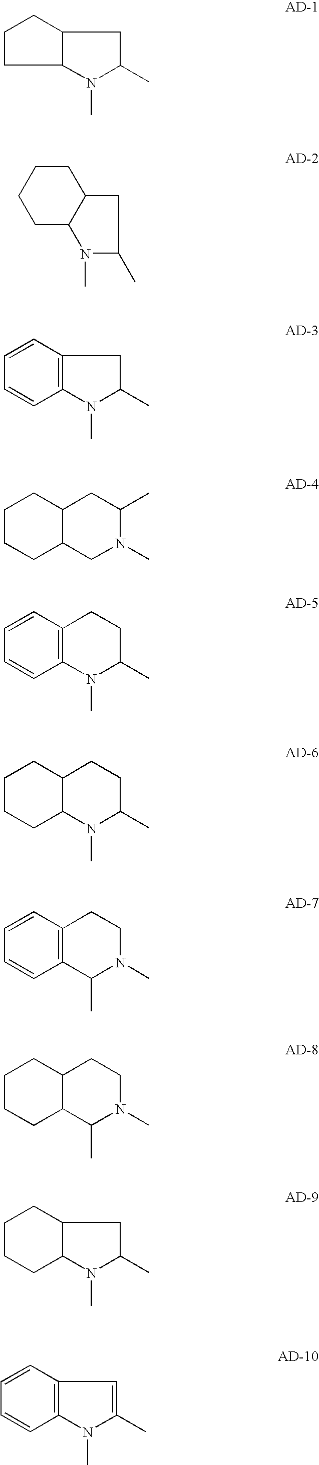

A and Q¹ together particularly preferably represent C₃-C₄-alkanediyl or C₃-C₄-alkenediyl, each of which is optionally mono- or disubstituted by identical or different substituents from the group consisting of C₁-C₂-alkyl and C₁-C₂-alkoxy, or
Q¹ particularly preferably represents hydrogen,
Q² particularly preferably represents hydrogen,
Q⁴, Q⁵ and Q⁶ independently of one another particularly preferably represent hydrogen or C₁-C₂-alkyl,
Q³ particularly preferably represents hydrogen, C₁-C₄-alkyl, C₁-C₄-alkoxy-C₁-C₂-alkyl, C₁-C₄-alkylthio-C₁-C₂-alkyl or optionally methyl- or methoxy-substituted C₃-C₆-cycloalkyl in which optionally one methylene group is replaced by oxygen or sulphur, or
Q³ and Q⁴ together with the carbon to which they are attached particularly preferably represent a saturated C₅-C₆-ring which is optionally mono- or disubstituted by C₁-C₄-alkyl or C₁-C₄-alkoxy and in which optionally one ring member is replaced by oxygen or sulphur,
   with the proviso that A then particularly preferably represents hydrogen or methyl,
G particularly preferably represents-chlorine or nitro.

In the radical definitions mentioned as being particularly preferred, halogen represents fluorine, chlorine, bromine and iodine, in particular fluorine, chlorine and bromine.
W and Z independently of one another very particularly preferably represent hydrogen, chlorine, bromine, methyl, ethyl, methoxy or ethoxy,
X very particularly preferably represents chlorine, bromine, methyl, ethyl, propyl, methoxy, ethoxy, trifluoromethyl, difluoromethoxy, trifluoromethoxy or cyano,
Y very particularly preferably represents hydrogen, chlorine, bromine, methyl, trifluoromethyl or represents the radical

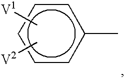

V¹ very particularly preferably represents hydrogen, fluorine, chlorine, bromine, methyl, ethyl, tert-butyl, methoxy, trifluoromethyl or trifluoromethoxy,
V² very particularly preferably represents hydrogen, fluorine, chlorine, methyl, methoxy or trifluoromethyl,
CDC very particularly preferably represents one of the groups

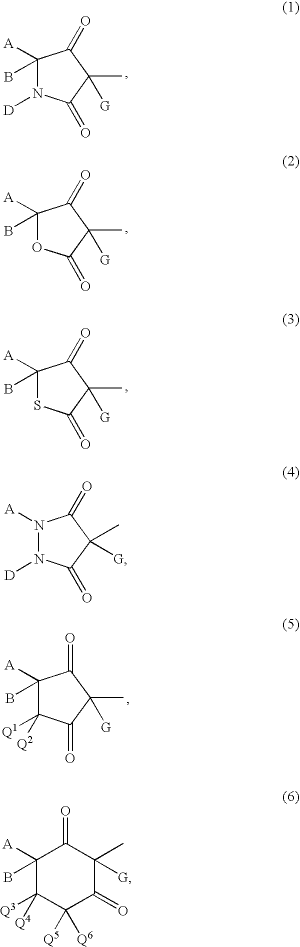

A very particularly preferably represents hydrogen, represents C₁₋₄-alkyl or C₁-C₂-alkoxy-C₁-C₂-alkyl, each of which is optionally mono- to trisubstituted by fluorine, or represents C₃-C₆-cycloalkyl which is optionally monosubstituted by fluorine, methyl or methoxy,
B very particularly preferably represents hydrogen, methyl or ethyl, or
A, B and the carbon atom to which they are attached very particularly preferably represent saturated C₅-C₆-cycloalkyl in which optionally one ring member is replaced by oxygen and which is optionally monosubstituted by methyl, trifluoromethyl, methoxy, ethoxy, propoxy, butoxy or isobutoxy, with the proviso that Q³ then very particularly preferably represents hydrogen, or
A, B and the carbon atom to which they are attached very particularly preferably represent C₅-C₆-cycloalkyl which is substituted by an alkylenedioxyl group which contains two not directly adjacent oxygen atoms, with the proviso that Q³ then very particularly preferably represents hydrogen,
D very particularly preferably represents hydrogen, represents C₁-C₄-alkyl, C₃-C₄-alkenyl, C₁-C₂-alkoxy-C₂-C₃-alkyl or C₃-C₆-cycloalkyl in which optionally one methylene group is replaced by oxygen or sulphur, each of which radicals is optionally mono- to trisubstituted by fluorine, or (but not in the case of the compounds of the formula (I-1)) represents phenyl or pyridyl, each of which is optionally mono- or disubstituted by fluorine, chlorine, bromine, methyl, ethyl, n-propyl, isopropyl, methoxy, ethoxy, trifluoromethyl or trifluoromethoxy,
or
A and D together very particularly preferably represent optionally substituted C₃-C₅-alkanediyl in which optionally one carbon atom is replaced by oxygen or sulphur and which is optionally mono- or disubstituted by methyl, or
A and D (in the case of the compounds of the formula (I-1)) together with the atoms to which they are attached very particularly preferably represent the group:

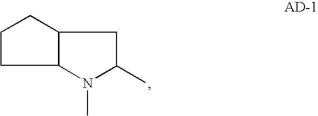

A and Q¹ together very particularly preferably represent C₃-C₄-alkanediyl which is optionally mono- or disubstituted by methyl or methoxy or
Q¹ very particularly preferably represents hydrogen,
Q² very particularly preferably represents hydrogen,
Q⁴, Q⁵ and Q⁶ independently of one another very particularly preferably represent hydrogen or methyl,
Q³ very particularly preferably represents hydrogen, methyl, ethyl or C₃-C₆-cycloalkyl, or
Q³ and Q⁴ together with the carbon to which they are attached very particularly preferably represent a saturated C₅-C₆-ring which is optionally monosubstituted by methyl or methoxy and in which optionally one ring member is replaced by oxygen or sulphur, with the proviso that A then very particularly preferably represents hydrogen,
G very particularly preferably represents chlorine or nitro,
W especially preferably represents hydrogen, chlorine, bromine, methyl, ethyl, methoxy or ethoxy,
X especially preferably represents chlorine, bromine, methyl, ethyl, propyl, methoxy, ethoxy, trifluoromethyl, difluoromethoxy, trifluoromethoxy or cyano,
Y especially preferably represents hydrogen, chlorine, bromine, methyl, trifluoromethyl or represents the radical

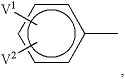

V¹ especially preferably represents hydrogen, fluorine, chlorine, bromine, methyl, ethyl, tert-butyl, methoxy, trifluoromethyl or trifluoromethoxy,
V² especially preferably represents hydrogen, fluorine, chlorine, methyl, methoxy or trifluoromethyl,
Z especially preferably represents hydrogen, methyl, chlorine or bromine,
CDC especially preferably represents one of the groups

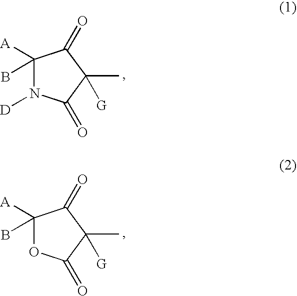

A especially preferably represents hydrogen, represents C₁-C₄-alkyl or C₁-C₂-alkoxy-C₁-C₂-alkyl, each of which is optionally mono- to trisubstituted by fluorine, or represents C₃-C₆-cycloalkyl which is optionally monosubstituted by fluorine, methyl or methoxy,
B especially preferably represents hydrogen, methyl or ethyl, or
A, B and the carbon atom to which they are attached especially preferably represent saturated C₅-C₆-cycloalkyl in which optionally one ring member is; replaced by oxygen and which is optionally monosubstituted by methyl, trifluoromethyl, methoxy, ethoxy, propoxy, butoxy or isobutoxy,
D especially preferably represents hydrogen,
G especially preferably represents chlorine.

The general or preferred radical definitions or illustrations given above can be combined with one another as desired, i.e. including combinations between the respective ranges and preferred ranges.

Preference according to the invention is given to the use of the compounds of the formula (I) which contain a combination of the meanings given above as being preferred (preferable).

Particular preference according to the invention is given to the use of the compounds of the formula (I) which contain a combination of the meanings given above as being particularly preferred.

Very particular preference according to the invention is given to the use of the compounds of the formula (I) which contain a combination of the meanings given above as being very particularly preferred.

Special preference according to the invention is given to the use of the compounds of the formula (I) which contain a combination of the meanings given above as being especially preferred.

Saturated or unsaturated hydrocarbon radicals, such as alkyl, alkylenediyl or alkenyl, can in each case be straight-chain or branched as far as this is possible, including in combination with heteroatoms, such as, for example, in alkoxy.

Unless indicated otherwise, optionally substituted radicals can be mono- or polysubstituted, where in the case of polysubstitution the substituents can be identical or different.

In addition to the compounds mentioned in the examples, the following compounds of the formula (I-1) may be specifically mentioned:

TABLE 1

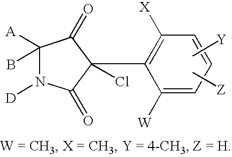

| A | B | D |
|---|---|---|
| CH₃ | CH₃ | H |
| C₂H₅ | CH₃ | H |
| C₃H₇ | CH₃ | H |
| i-C₃H₇ | CH₃ | H |
| 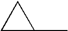 | CH₃ | H |

| | |
|---|---|
| —(CH₂)₄ | H |
| —(CH₂)₅— | H |
| —(CH₂)₂—O—(CH₂)₂— | H |
| —CH₂—O—(CH₂)₃— | H |
| —CH₂—CHCH₃—(CH₂)₃— | H |
| —(CH₂)₂—CHCH₃—(CH₂)₂— | H |
| —(CH₂)₂—CHOCH₃—(CH₂)₂— | H |
| —(CH₂)₂—CHOC₂H₅—(CH₂)₂— | H |
| —(CH₂)₂—C(CH₃)₂—(CH₂)₂— | H |

Table 2: A, B and D as stated in Table 1
W═CH₃; X═CH₃; Y=4-Cl; Z=H;

Table 3: A, B and D as stated in Table 1
W═CH₃; X═CH₃; Y=4-Br, Z=H;

Table 4: A, B and D as stated in Table 1
W═C₂H₅; X═CH₃; Y=4-Cl; Z=H;

Table 5: A, B and D as stated in Table 1
W═C₂H₅; X═CH₃; Y=4-Br, Z=H;

Table 6: A, B and D as stated in Table 1
W═C₂H₅; X═C₂H₅; Y=4-Cl; Z=H;

Table 7: A, B and D as stated in Table 1
W═C₂H₅; X═C₂H₅; Y=4-Br, Z=H;

Table 8: A, B and D as stated in Table 1
W═CH₃; X═Cl; Y=4-Cl; Z=H;

Table 9: A, B and D as stated in Table 1
W≡CH₃; X═Br; Y=4-Br; Z=H;

Table 10: A, B and D as stated in Table 1
W═CH₃; X═Cl; Y=4-Br, Z=H;

Table 11: A, B and D as stated in Table 1
W═CH₃; X═Br, Y 4-Cl; Z=H;

Table 12: A, B and D as stated in Table 1
W═C₂H₅; X═Cl; Y=4-Cl; Z=H;

Table 13: A, B and D as stated in Table 1
W═C₂H₅; X═Br, Y=4-Br, Z=H;

Table 14: A, B and D as stated in Table 1
W═C₂H₅; X═Cl; Y=4-Br, Z=H;

Table 15: A, B and D as stated in Table 1
W═CH₅; X═Br; Y=4-Cl; Z=H;

Table 16: A, B and D as stated in Table 1
W═H; X═CH₃; Y═H; Z=H;

Table 17: A, B and D as stated in Table 1
W═H; X═Cl; Y═H; Z=H;

Table 18: A, B, and D as stated in Table 1
W═H; X═Br; Y═H; Z=H;

Table 19: A, B and D as stated in Table 1
W═H; X═CH; Y=4-Cl; Z=H;

Table 20: A, B and D as stated in Table 1
W═H; X═Cl; Y=4-CH₃; Z=H;

Table 21: A, B and D as stated in Table 1
W═H; X═CH₃; Y=4-CH₃; Z=H;

Table 22: A, B and D as stated in Table 1
W═H; X═Cl; Y=4-Cl; Z=H

Table 23: A, B and D as stated in Table 1
5. Table 24: A, B and D as stated in Table 1
W═CH₃; X═Cl; Y=4-CH₃; Z=H;

Table 25: A, B and D as stated in Table 1:
W═CH₃; X═Br; Y=4-CH₃; Z=H;

Table 26: A, B and D as stated in Table 1
W═C₂H₅; X═Cl; Y=4-CH₃; Z=H;

Table 27: A, B and D as stated in Table 1
W═C₂H₅; X═Br, Y 4-CH₃; Z=H;

Table 28: A, B and D as stated in Table 1
W═C₂H₅; X═CH₃; Y=4-C₁₃; Z=H;

Table 29: A, B and D as stated in Table 1
W═C₂H₅; X═C₂H₅; Y=4-CH₃; Z=H;

Table 30: A, B and D as stated in Table 1
W═H; X═CH₃; Y=4-CH₃; Z=5-CH₃.

Table 31: A, B and D as stated in Table 1
W═H; X═CH₃; Y=4-Cl; Z=5-CH₃.:

Table 32: A, B and D as stated in Table 1
W═H; X═Br; Y=4-CH₃; Z=5-CH₃.

Table 33: A, B and D as stated in Table 1
W═H; X═Cl; Y=4-Cl; Z=5-CH₃.

Table 34: A, B and D as stated in Table 1
W═H; X═CH₃; Y=4-Br; Z=5-CH₃.

Table 35: A, B and D as stated in Table 1
W═H; X═Cl; Y=4-CH₃; Z=5-CL.

Table 36: A, B and D as stated in Table 1
W═H; X═CH₃; Y═H; Z=5-CH₃.

Table 37: A, B and D as stated in Table 1
W═H; X═Cl; Y═H; Z=5-CH₃.

Table 38: A, B and D as stated in Table 1
W═H; X═Br; Y═H; Z=5-CH₃.

Table 39: A, B and D as stated in Table 1
W═CH₃; X═CH₃; Y=4-CH₃; Z=3-CH₃.

Table 40: A, B and D as stated in Table 1
W═CH₃; X═CH₃; Y=4-CH₃; Z=3-Cl.

Table 41: A, B and D as stated in Table 1
W═CH₃; X═CH₃; Y=4-CH₃; Z=3-Br.

Table 42: A, B and D as, stated in Table 1
W═CH₃; X═CH₃; Y═H; Z=3-Cl.

Table 43: A, B and D as stated in Table 1
W═CH₃; X═CH₃; Y═H; Z=3-Br.

The compounds of the formula (I) are known in principle from the laid-open publications cited at the outset, or they can be prepared by the processes described therein.

Preferred meanings of the groups listed above in connection with the crop plant compatibility-improving compounds (“herbicide safeners”) of the formulae (IIa), (IIb), (IIc), (IId) and (IIe) are defined below.
m preferably represents the numbers 0, 1, 2, 3 or 4.

A¹ preferably represents one of the divalent heterocyclic groupings shown below

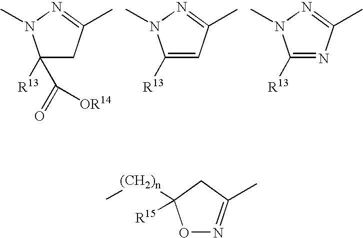

n preferably represents the numbers 0, 1, 2, 3 or 4.
A² preferably represents in each case optionally methyl-, ethyl-, methoxycarbonyl- or ethoxycarbonyl- or allyloxycarbonyl-substituted methylene or ethylene.
R⁸ preferably represents hydroxyl, mercapto, amino, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or, t-butylamino, dimethylamino or diethylamino.
R⁹ preferably represents hydroxyl, mercapto, amino, methoxy, ethoxy, n- or i-propoxy, n-, i-, s- or t-butoxy, 1-methylhexyloxy, allyloxy, 1-allyloxymethylethoxy, methylthlio, ethylthio, n- or i-propylthio, n-, i-, s- or t-butylthio, methylamino, ethylamino, n- or i-propylamino, n-, i-, s- or t-butylamino, dimethylamino or diethylamino.
R¹⁰ preferably represents in each case optionally fluorine-, chlorine- and/or bromine-substituted methyl, ethyl, n- or i-propyl.
R¹¹ preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxy ethyl, methoxyethyl, ethoxyethyl, dioxolanylmethyl, furyl, furylmethyl, thienyl, thiazolyl, piperidinyl, or optionally fluorine-, chlorine-, methyl-, ethyl-, n- or i-propyl-, n-, i-, s- or t-butyl-substituted phenyl.
R¹² preferably represents hydrogen, in each case optionally fluorine- and/or chlorine-substituted methyl, ethyl, n- or i-propyl, n-, i-, s- or t-butyl, propenyl, butenyl, propynyl or butynyl, methoxymethyl, ethoxymethyl, methoxyethyl, ethoxyethyl, dioxolanylmethyl, furyl, furylethyl, thienyl, thiazolyl, piperidinyl, or optionally fluorine-, chlorine-, methyl-, ethyl-, n- or i-propyl-, n-, i-, s- or t-butyl-substituted phenyl, or together with R¹¹ represents one of the radicals —CH₂—O—CH₂—CH₂— and —CH₂—CH₂—O—CH₂—CH₂—, which are optionally substituted by methyl, ethyl, furyl, phenyl, a fused-on benzene ring or by two substituents which together with the C atom to which they are attached form a 5- or 6-membered carbocycle.
R¹³ preferably represents hydrogen, cyano, fluorine, chlorine, bromine, or represents in each case optionally fluorine-, chlorine- and/or bromine-substituted methyl, ethyl, n- or i-propyl, cyclopropyl, cyclobutyl, cyclopentyl, cyclohexyl or phenyl.
R¹⁴ preferably represents hydrogen, optionally hydroxyl-, cyano-, fluorine-, chlorine-, methoxy-, ethoxy-, n- or i-propoxy-substituted methyl, ethyl, n- or i-propyl, n-, i-, s- or t-butyl.
R¹⁵ preferably represents hydrogen, cyano, fluorine, chlorine, bromine, or represents in each case optionally fluorine-, chlorine- and/or bromine-substituted methyl, ethyl, n- or i-propyl, n-, i-, s- or t-butyl, cyclopropyl, cyclobutyl, cyclopentyl, cyclohexyl or phenyl.
X¹ preferably represents nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X² preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
X³ preferably represents hydrogen, nitro, cyano, fluorine, chlorine, bromine, methyl, ethyl, n- or i-propyl, n-, i-, s- or t-butyl, difluoromethyl, dichloromethyl, trifluoromethyl, trichloromethyl, chlorodifluoromethyl, fluorodichloromethyl, methoxy, ethoxy, n- or i-propoxy, difluoromethoxy or trifluoromethoxy.
t preferably represents the numbers 0, 1, 2, 3 or 4.
v preferably represents the numbers 0, 1, 2, 3 or 4.
R¹⁶ preferably represents hydrogen, methyl, ethyl, n- or i-propyl.
R¹⁷ preferably represents hydrogen, methyl, ethyl, n- or i-propyl.
R¹⁸ preferably represents hydrogen, in each case optionally cyano-, fluorine-, chlorine-, methoxy-, ethoxy-, n- or i-propoxy-substituted methyl, ethyl, n- or i-propyl, n-, i-, s- or t-butyl, methoxy, ethoxy, n- or i-propoxy, n-, i-, s- or t-butoxy, methylthio, ethylthio, n- or i-propylthio, n-, i-, s- or t-butylthio, methylamino, ethylamino, n- or i-propylamino, n-, i-, s- or t-butylamino, dimethylamino or diethylamino, or in each case optionally cyano-, fluorine-, chlorine-, bromine-, methyl-, ethyl-, n- or i-propyl-substituted cyclopropyl, cyclobutyl, cyclopentyl, cyclohexyl, cyclopropyloxy, cyclobutyloxy, cyclopentyloxy, cyclohexyloxy, cyclopropylthio, cyclobutylthio, cyclopentylthio, cyclohexylthio, cyclopropylamino, cyclobutylamino, cyclopentylamino or cyclohexylamino.
R¹⁹ preferably represents hydrogen, in each case optionally cyano, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, or in each case optionally cyano-, fluorine-, chlorine-, bromine-, methyl-, ethyl-, n- or i-propyl-substituted cyclopropyl, cyclobutyl, cyclopentyl or cyclohexyl.
R²⁰ preferably represents hydrogen, represents in each case optionally cyano-, hydroxyl-, fluorine-, chlorine-, methoxy-, ethoxy-, n- or i-propoxy-substituted methyl, ethyl, n- or i-propyl, n-, i- or s-butyl, in each case optionally cyano-, fluorine-, chlorine- or bromine-substituted propenyl, butenyl, propynyl or butynyl, in each case optionally cyano-, fluorine-, chlorine-, bromine-, methyl-, ethyl-, n- or i-propyl-substituted cyclopropyl, cyclobutyl, cyclopentyl or cyclohexyl, or optionally nitro, cyano-, fluorine-, chlorine-, bromine-, methyl-, ethyl-, n- or i-propyl-, n-, i-, s- or t-butyl-, trifluoromethyl-, methoxy-, ethoxy-, n- or i-propoxy-, difluoromethoxy- or trifluoromethoxy-substituted phenyl, or together with R¹⁹ represents in each case optionally methyl- or ethyl-substituted butane-1,4-diyl (trimethylene), pentane-1,5-diyl, 1-oxa-butane-1,4-diyl or 3-oxa-pentane-1,5-diyl.
X⁴ preferably represents nitro, cyano, carboxyl, carbamoyl, formyl, sulphamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluoromethoxy or trifluoromethoxy.
X⁵ preferably represents nitro, cyano, carboxyl, carbamoyl, formyl, sulphamoyl, hydroxyl, amino, fluorine, chlorine, bromine, methyl, ethyl, n- or i-propyl, n-, i-, s- or t-butyl, trifluoromethyl, methoxy, ethoxy, n- or i-propoxy, difluormethoxy or trifluoromethoxy.

Examples of compounds of the formula (IIa) which are very particularly preferred as herbicide safeners according to the invention are listed in the table below.

TABLE
Examples of the compounds of the formula (IIa)

| | |
|---|---|
| | (IIa) |
| 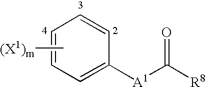 | |

| Example | (Positions) | | |
|---|---|---|---|
| No. | (X¹)ₘ | A¹ | R⁸ |
| IIa-1 | (2) Cl, (4) Cl | 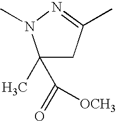 | OCH₃ |
| IIa-2 | (2) Cl, (4) Cl | 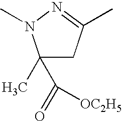 | OCH₃ |
| IIa-3 | (2) Cl, (4) Cl | 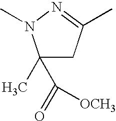 | OC₂H₅ |
| IIa-4 | (2) Cl, (4) Cl | 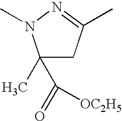 | OC₂H₅ |
| IIa-5 | (2) Cl | 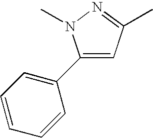 | OCH₃ |
| IIa-6 | (2) Cl, (4) Cl | 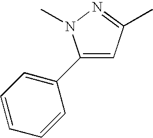 | OCH₃ |
| IIa-7 | (2) F | 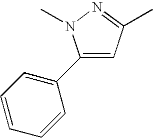 | OCH₃ |
| IIa-8 | (2) F | 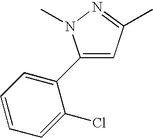 | OCH₃ |
| IIa-9 | (2) Cl, (4) Cl | 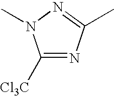 | OC₂H₅ |
| IIa-10 | (2) Cl, (4) CF₃ | 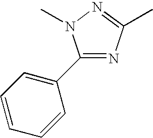 | OCH₃ |
| IIa-11 | (2) Cl | 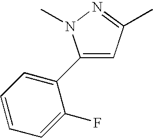 | OCH₃ |
| IIa-12 | — | 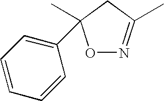 | OC₂H₅ |
| IIa-13 | (2) Cl, (4) Cl | 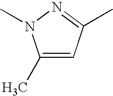 | OC₂H₅ |
| IIa-14 | (2) Cl, (4) Cl | 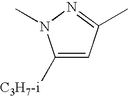 | OC₂H₅ |
| IIa-15 | (2) Cl, (4) Cl | 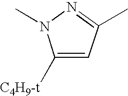 | OC₂H₅ |
| IIa-16 | (2) Cl, (4) Cl | 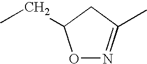 | OC₂H₅ |
| IIa-17 | (2) Cl, (4) Cl | 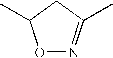 | OC₂H₅ |
| IIa-18 | — | 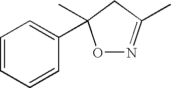 | OH |

Examples of compounds of the formula (IIb) which are very particularly preferred as herbicide safeners according to 6 the invention are listed in the table below.

TABLE
Examples of compounds of the formula (IIb)

| | |
|---|---|
| | (IIb) |
| 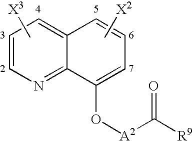 | |

| Example | (Position) | (Position) | | |
|---|---|---|---|---|
| No. | X² | X³ | A² | R⁹ |
| IIb-1 | (5) | — | CH₂ | OH |
| | Cl | | | |
| IIb-2 | (5) | — | CH₂ | OCH₃ |
| | Cl | | | |
| IIb-3 | (5) | — | CH₂ | OC₂H₅ |
| | Cl | | | |
| IIb-4 | (5) | — | CH₂ | OC₃H₇-n |
| | Cl | | | |
| IIb-5 | (5) | — | CH₂ | OC₃H₇-i |
| | Cl | | | |
| IIb-6 | (5) | — | CH₂ | OC₄H₉-n |
| | Cl | | | |
| IIb-7 | (5) | — | CH₂ | OCH(CH₃)C₅H₁₁-n |
| | Cl | | | |
| IIb-8 | (5) | (2) | CH₂ | OH |
| | Cl | F | | |
| IIb-9 | (5) | (2) | CH₂ | OH |
| | Cl | Cl | | |
| IIb-10 | (5) | — | CH₂ | OCH₂CH═CH₂ |
| | Cl | | | |
| IIb-11 | (5) | — | CH₂ | OC₄H₉-i |
| | Cl | | | |
| IIb-12 | (5)Cl | — | CH₂ | 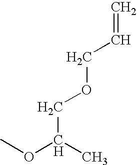 |
| IIb-13 | (5)Cl | — | 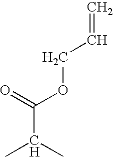 | OCH₂CH═CH₂ |
| IIb-14 | (5)Cl | — | 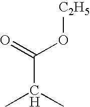 | OC₂H₅ |
| IIb-15 | (5)Cl | — | 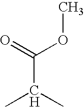 | OCH₃ |

Examples of the compounds of the formula (IIc) which are very particularly preferred as herbicide safeners according to the invention are listed in the table below.

TABLE
Examples of the compounds of the formula (IIc)

| | |
|---|---|
| | (IIc) |
| 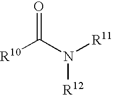 | |

| Example | | |
|---|---|---|
| No. | R¹⁰ | N(R¹¹, R¹²) |
| IIc-1 | CHCl₂ | N(CH₂CH═CH₂)₂ |
| IIc-2 | CHCl₂ | 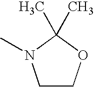 |
| IIc-3 | CHCl₂ | 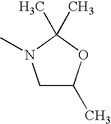 |
| IIc-4 | CHCl₂ | 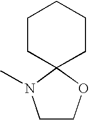 |
| IIc-5 | CHCl₂ | 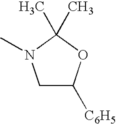 |
| IIc-6 | CHCl₂ | 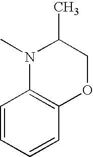 |
| IIc-7 | CHCl₂ | 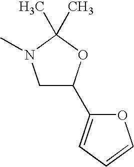 |

Examples of the compounds of the formula (IId) which are very particularly preferred as herbicide safeners according to the invention are listed in the table below.

TABLE
Examples of the compounds of the formula (IId)

| | |
|---|---|
| | (IId) |
| 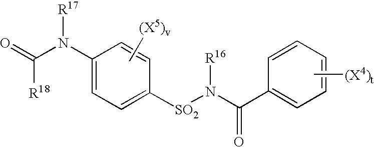 | |

| Example | | | | (Positions) | (Positions) |
|---|---|---|---|---|---|
| No. | R¹⁶ | R¹⁷ | R¹⁸ | (X⁴)ₜ | (X⁵)ᵥ |
| IId-1 | H | H | CH₃ | (2) OCH₃ | — |
| IId-2 | H | H | C₂H₅ | (2) OCH₃ | — |
| IId-3 | H | H | C₃H₇-n | (2) OCH₃ | — |
| IId-4 | H | H | C₃H₇-i | (2) OCH₃ | — |
| IId-5 | H | H | 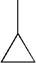 | (2) OCH₃ | — |
| IId-6 | H | H | CH₃ | (2) OCH₃ | — |
| | | | | (5) CH₃ | |
| IId-7 | H | H | C₂H₅ | (2) OCH₃ | — |
| | | | | (5) CH₃ | |
| IId-8 | H | H | C₃H₇-n | (2) OCH₃ | — |
| | | | | (5) CH₃ | |
| IId-9 | H | H | C₃H₇-i | (2) OCH₃ | — |
| | | | | (5) CH₃ | |
| IId-10 | H | H | 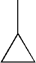 | (2) OCH₃(5) CH₃ | — |
| IId-11 | H | H | OCH₃ | (2) OCH₃ | — |
| | | | | (5) CH₃ | |
| IId-12 | H | H | OC₂H₅ | (2) OCH₃ | — |
| | | | | (5) CH₃ | |
| IId-13 | H | H | OC₃H₇-i | (2) OCH₃ | — |
| | | | | (5) CH₃ | |
| IId-14 | H | H | SCH₃ | (2) OCH₃ | — |
| | | | | (5) CH₃ | |
| IId-15 | H | H | SC₂H₅ | (2) OCH₃ | — |
| | | | | (5) CH₃ | |
| IId-16 | H | H | SC₃H₇-i | (2) OCH₃ | — |
| | | | | (5) CH₃ | |
| IId-17 | H | H | NHCH₃ | (2) OCH₃ | — |
| | | | | (5) CH₃ | |
| IId-18 | H | H | NHC₂H₅ | (2) OCH₃ | — |
| | | | | (5) CH₃ | |
| IId-19 | H | H | NHC₃H₇-i | (2) OCH₃ | — |
| | | | | (5) CH₃ | |
| IId-20 | H | H | 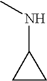 | (2) OCH₃(5) CH₃ | — |
| IId-21 | H | H | NHCH₃ | (2) OCH₃ | — |
| IId-22 | H | H | NHC₃H₇-i | (2) OCH₃ | — |
| IId-23 | H | H | N(CH₃)₂ | (2) OCH₃ | — |
| IId-24 | H | H | N(CH₃)₂ | (3) CH₃ | — |
| | | | | (4) CH₃ | |
| IId-25 | H | H | CH₂—O—CH₃ | (2) OCH₃ | — |

Examples of the compounds of the formula (IIe) which are very particularly preferred as herbicide safeners according to the invention are listed in the table below.

TABLE
Examples of the compounds of the formula (IIe)

| | |
|---|---|
| | (IIe) |
| 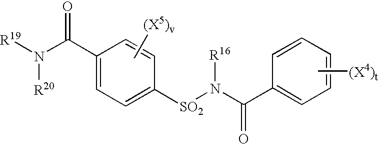 | |

| Example | | | | (Positions) | (Positions) |
|---|---|---|---|---|---|
| No. | R¹⁶ | R¹⁹ | R²⁰ | (X⁴)ₜ | (X⁵)ᵥ |
| IIe-1 | H | H | CH₃ | (2) OCH₃ | — |
| IIe-2 | H | H | C₂H₅ | (2) OCH₃ | — |
| IIe-3 | H | H | C₃H₇-n | (2) OCH₃ | — |
| IIe-4 | H | H | C₃H₇-i | (2) OCH₃ | — |
| IIe-5 | H | H | 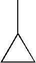 | (2) OCH₃ | — |
| IIe-6 | H | CH₃ | CH₃ | (2) OCH₃ | — |
| IIe-7 | H | H | CH₃ | (2) OCH₃ | — |
| | | | | (5) CH₃ | |
| IIe-8 | H | H | C₂H₅ | (2) OCH₃ | — |
| | | | | (5) CH₃ | |
| IIe-9 | H | H | C₃H₇-n | (2) OCH₃ | — |
| | | | | (5) CH₃ | |
| IIe-10 | H | H | C₃H₇-i | (2) OCH₃ | — |
| | | | | (5) CH₃ | |
| IIe-11 | H | H | 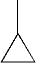 | (2) OCH₃(5) CH₃ | — |
| IIe-12 | H | CH | CH₃ | (2) OCH₃ | — |
| | | | | (5) CH₃ | |

Most preference is given as the crop plant compatibility-improving compound [component (b)] to cloquintocet-mexyl, fenchlorazole-ethyl, isoxadifen-ethyl, mefenpyr-diethyl, furilazole, fenclorim, cumyluron, dymron, dichlorimid, dimepiperate and the compounds. IIe-5, and IIe-11, with cloquintocet-mexyl, mefenpyr-diethyl, isoxadifen-ethyl, furilazole, dichlormid, fenclorim and IIe-5 being particularly emphasized.

Examples of the selectively herbicidal combinations according to the invention of in each case one active compound of the formula (I) and in each case one of the safeners defined above are listed in the table below.

TABLE
Examples of combinations according to the invention

| Active compounds of the formula (I) | Safener |
|---|---|
| I-1 | cloquintocet-mexyl |
| I-1 | fenchlorazole-ethyl |
| I-1 | isoxadifen-ethyl |
| I-1 | mefenpyr-diethyl |
| I-1 | furilazole |
| I-1 | fenclorim |
| I-1 | cumyluron |
| I-1 | daimuron/dymron |
| I-1 | dichlormid |
| I-1 | dimepiperate |
| I-1 | IIe-11 |
| I-1 | IIe-5 |
| I-2 | cloquintocet-mexyl |
| I-2 | fenchlorazole-ethyl |
| I-2 | isoxadifen-ethyl |
| I-2 | mefenpyr-diethyl |
| I-2 | furilazole |
| I-2 | fenclorim |
| I-2 | cumyluron |
| I-2 | daimuron/dymron |
| I-2 | dichlormid |
| I-2 | dimepiperate |
| I-2 | IIe-11 |
| I-2 | IIe-5 |
| I-3 | cloquintocet-mexyl |
| I-3 | fenchlorazole-ethyl |
| I-3 | isoxadifen-ethyl |
| I-3 | mefenpyr-diethyl |
| I-3 | furilazole |
| I-3 | fenclorim |
| I-3 | cumyluron |
| I-3 | daimuron/dymron |
| I-3 | dichlormid |
| I-3 | dimepiperate |
| I-3 | IIe-5 |
| I-3 | IIe-11 |
| I-4 | cloquintocet-mexyl |
| I-4 | fenchlorazole-ethyl |
| I-4 | isoxadifen-ethyl |
| I-4 | mefenpyr-diethyl |
| I-4 | furilazole |
| I-4 | fenclorim |
| I-4 | cumyluron |
| I-4 | daimuron/dymron |
| I-4 | dichlormid |
| I-4 | dimepiperate |
| I-4 | IIe-11 |
| I-4 | IIe-5 |
| I-5 | cloquintocet-mexyl |
| I-5 | fenchlorazole-ethyl |
| I-5 | isoxadifen-ethyl |
| I-5 | mefenpyr-diethyl |
| I-5 | furilazole |
| I-5 | fenclorim |
| I-5 | cumyluron |
| I-5 | daimuron/dymron |
| I-5 | dichlormid |
| I-5 | dimepiperate |
| I-5 | IIe-5 |
| I-5 | IIe-11 |
| I-6 | cloquintocet-mexyl |
| I-6 | fenchlorazole-ethyl |
| I-6 | isoxadifen-ethyl |
| I-6 | mefenpyr-diethyl |
| I-6 | furilazole |
| I-6 | fenclorim |
| I-6 | cumyluron |
| I-6 | daimuron/dymron |
| I-6 | dichlormid |
| I-6 | dimepiperate |
| I-6 | IIe-5 |
| I-6 | IIe-11 |

The compounds of the general formula (IIa) to be used as safeners are known and/or can be prepared by processes known per se (cf. WO-A-91/07874, WO-A-95/07897).

The compounds of the general formula (IIb) to be used as safeners are known and/or can be prepared by processes known per se (cf. EP-A-191736).

The compounds of the general formula (IIc) to be used as safeners are known and/or can be prepared by processes known per se (cf. DE-A-2218097, DE-A-2350547).

The compounds of the general formula (IId) to be used as safeners are known and/or can be prepared by processes known per se (cf DE-A-9621522/U.S. Pat. No. 6,235,680).

The compounds of the general formula (IIe) to be used as safeners are known and/or can be prepared by processes known per se (cf. WO-A-99/66795/U.S. Pat. No. 6,251,827).

Surprisingly, it has now been found that the above-defined active compound combinations of substituted aryl ketones of the general formula (I) and safeners (antidotes) of group (b) listed above, whilst being tolerated very well by useful plants, have good insecticidal and/or acaricidal activity and can be used in various crops, in particular in cereal (especially barley), but also in millet, maize and rice, for the selective control of insects.

Here, it has to be considered to be surprising that, from a large number of known safeners or antidotes which are capable of antagonizing the damaging effect of a herbicide on the crop plants, it is in particular the abovementioned compounds of group (b) which neutralize the damaging effect of substituted cyclic dicarbonyl compounds of the formula (I) on the crop plants virtually completely without negatively affecting the insecticidal and/or acaricidal activity with respect to the weeds.

Furthermore, it has to be considered to be completely surprising that compounds from group (b) listed above are not only capable of virtually completely neutralizing the damaging effect of substituted cyclic dicarbonyl compounds of the formula (I) on the crop plants but in some cases even enhance the insecticidal and/or acaricidal activity of the cyclic dicarbonyl compounds of the formula (I), so that a synergistic effect can be observed.

Emphasis is given here to the particularly advantageous effect of the particularly and most preferred combination partners from group (b), in particular in respect of sparing cereal plants, such as, for example, wheat, barley and rye, but also millet, maize and rice, as crop plants.

The combinations of active compounds can generally be used, for example, for the following plants:

Dicotyledonous crops of the genera: Gossypium, Glycine, Beta, Daucus, Phaseolus, Pisum, Solanum, Linum, Ipomoea, Vicia, Nicotiana, Lycopersicon, Arachis, Brassica, Lactuca, Cucumis, Cuburbita, Helianthus.

Monocotyledonous crops of the genera: Oryza, Zea, Triticum, Hordeum, Avena, Secale, Sorghum, Panicum, Saccharum, Ananas, Asparagus, Allium.

However, the use of the combinations of active compounds is by no means limited to these genera but equally also extends to other plants.

The advantageous effect of the combinations of active compounds is particularly strongly pronounced at certain concentration ratios. However, the weight ratios of the active compounds in the combinations of active compounds can be varied within relatively wide ranges. In general, 0.001 to 1000 parts by weight, preferably 0.01 to 100 parts by weight, particularly preferably 0.05 to 10 parts by weight and most preferably 0.07 to 1.5 parts by weight of one of the crop plant compatibility-improving compounds (antidotes/safeners) mentioned above under (b) are present per part by weight of active compound of the formula (I) or salts thereof.

The active compounds or active compound combinations can be converted into the customary formulations, such as solutions, emulsions, wettable powders, suspensions, powders, dusts, pastes, soluble powders, granules, suspoemulsion concentrates, natural and synthetic materials impregnated with active compound and microencapsulations in polymeric materials.

These formulations are produced in a known manner, for example by mixing the active compounds with extenders, that is, liquid solvents and/or solid carriers, optionally with the use of surface-active agents, that is, emulsifiers and/or dispersants and/or foam formers.

If the extender used is water, it is also possible to use for example organic solvents as auxiliary solvents. Suitable liquid solvents are mainly: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral and vegetable oils, alcohols, such as butanol or glycol and ethers and esters thereof, ketones, such as acetone, methyl ethyl ketone, methyl isobutyl ketone or cyclohexanone, strongly polar solvents, such as dimethylformamide and dimethyl sulphoxide, and water.

Suitable solid carriers are:

for example ammonium salts and ground natural minerals, such as kaolins, clays, talc, chalk, quartz, attapulgite, montmorillonite or diatomaceous earth, and ground synthetic minerals, such as finely divided silica, alumina and silicates; suitable as solid carriers for granules are: for example crushed and fractionated-natural rocks such as calcite, marble, pumice, sepiolite and dolomite, and synthetic granules of inorganic and organic meals, and granules of organic material such as sawdust, coconut shells, maize cobs and tobacco stalks; suitable as emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates; suitable as dispersants are: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids can be used in the formulations. Other possible additives are mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations in general comprise between 0.1 and 95% by weight of active compounds, including the active compounds with a safening effect, preferably between 0.5 and 90%.

The combinations of active compounds are generally applied in the form of ready-to-use formulations. However, the active compounds contained in the combinations of active compounds may also be applied in the form of individual formulations which are mixed upon use, that is, in the form of tank mixes.

The combinations of active compounds, as such or in their formulations, may furthermore also be used as a mixture with other known herbicides, again with ready-to-use formulations or tank mixes being possible. A mixture with other known active compounds, such as fungicides, insecticides, acaricides, nematicides, attractants, steriliants, bactericides, bird repellents, growth substances, plant nutrients and soil conditioners is also possible. It may furthermore be advantageous for specific applications, in particular for the post-emergence method, to incorporate into the formulations plant-compatible mineral or vegetable oils (for example the commercial product “Rako Binol”) or ammonium salts, such as, for example, ammonium sulphate or ammonium thiocyanate, as further additives.

The combinations of active compounds can be used as such, in the form of their formulations or the use forms which can be prepared from these formulations by further dilution, such as ready-to-use solutions, suspensions, emulsions, powders, pastes and granules. Application is effected in the customary manner, for example by watering, spraying, atomizing, dusting or broadcasting.

The application rates of the combinations of active compound can be varied within a certain range; they depend inter alia on the weather and on the soil factors. In general, the application rates are between 0.005 and 5 kg per ha, preferably between 0.01 and 2 kg per ha, particularly preferably between 0.05 and 1.0 kg per ha.

The combinations of active compounds can be applied before and after emergence of the plants, i.e. by the pre-emergence and the post-emergence method.

Depending on their properties, the safeners to be used can be employed for pretreating the seed of the crop plant (seed dressing) or be incorporated into the seed furrows before sowing or, together with the herbicide, be applied before or after emergence of the plants.

The combinations of active compounds are suitable for controlling animal pests, preferably arthropods and nematodes, in particular insects and arachnids, encountered in agriculture, in animal healthcare, in forests, in the protection of stored products and in the protection of materials, and also in the hygiene sector. They are effective against normally sensitive and resistant species and against all or individual stages of development. The abovementioned pests include:

From the order of the Isopoda, for example, Oniscus asellus, Armadillidium vulgare, Porcellio scaber.

From the order of the Diplopoda, for example, Blaniulus guttulatus.

From the order of the Chilopoda, for example, Geophilus carpophagus, Scutigera spp.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Acheta domesticus, Gryllotalpa spp., Locusta migratoria migratorioides, Melanoplus spp., Schistocerca gregaria.

From the order of the Blattaria, for example, Blatta orientalis, Periplaneta americana, Leucophaea maderae, Blattella germanica.

From the order of the Dermaptera, for example, Forficula auricularia.

From the order of the Isoptera, for example, Reticulitermes spp.

From the order of the Phthiraptera, for example, Pediculus humanus corporis, Haematopinus spp., Linbgnathus spp., Trichodectes spp., Damalinia spp.

From the order of the Thysanoptera, for example, Hercinothrips femoralis, Thrips tabaci, Thrips palmi, Frankliniella occidentalis.

From the order of the Heteroptera, for example, Eurygaster spp., Dysdercus intermedius, Piesma quadrata, Cimex lectularius, Rhodnius prolixus, Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium comi, Saissetia oleae, Laodelphax striatellus, Nilaparvata lugens, Aonidiella aurantii, Aspidiotus hederae, Pseudococcus spp., Psylla spp.

From the order of the Lepidoptera, for example, Pectinophora gossypiella, Bupalus piniarius, Chematobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Eaias insulana, Heliothis spp., Mamestra brassicae, Panolis flammea, Spodoptera spp., Trichoplusia ni, Carpocapsa pomonella, Pieris spp., Chilo spp., Pyrusta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima, Tortrix viridana, Cnaphalocerus spp., Oulema oryzae.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis, Costelytra zealandica, Lissorhoptrus oryzophilus.

From the order of the Hymenoptera, for example, Diprion spp., Hoplocampa spp., Lasius spp., Monomorium pharaonis, Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., estrus spp., Hypoderma spp., Tabanus spp., Tannia spp., Bibio hortulanus, Oscinella frit, Phorbia spp., Pegoinyia hyoscyami, Ceratitis capitata, Dacus oleae, Tipula paludosa, Hylemyia spp., Liriomyza spp.

From the order of the Siphonaptera, for example, Xenopsylla cheopis, Ceratophyllus spp.

From the class of the arachnids, for example, Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp., Brevipalpus spp.

The plant-parasitic nematodes include, for example, Pratylenchus spp., Radopholus similis, Ditylenchus dipsaci, Tylenchulus semipenetrans, Heterodera spp., Globodera spp., Meioidogyne spp., Aphelenchoides spp., Longidorus spp., Xiphinema spp., Trichodorus spp., Bursaphelenchus spp.

When used as insecticides, the combinations of active compounds can furthermore be present, in their commercial formulations and in the use forms prepared from these formulations, as a mixture with synergists. Synergists are compounds which enhance the activity of the active compounds, without it being necessary for the added synergist to be active for its part

The content of active compounds of the use forms prepared from the commercial formulations may vary within wide ranges. The concentration of active compounds of the use forms may be from 0.0000001 to 95% by weight of active compound and is preferably from 0.0001 to 1% by weight.

Application is carried out in a customary manner adapted to the use forms.

According to the invention, it is possible to treat all plants and parts of plants. Plants are to be understood here as meaning all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant cultivars which can or cannot be protected by plant breeder's certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested plants and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multi-layer coating.

As already mentioned above, it is possible to treat all plants and their parts according to the invention. In a preferred embodiment, wild plant species and plant varieties, or those obtained by conventional biological breeding methods, such as crossing or protoplast fusion, and parts thereof, are treated. In a further preferred embodiment, transgenic plants and plant varieties obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant varieties which are in each case commercially available or in use are treated according to the invention.

Depending on the plant species or plant varieties, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant varieties (i.e. those obtained by genetic engineering) which are preferred and to be treated according to the invention include all plants which, in the genetic modification, received genetic material which imparts particularly advantageous useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defense of the plants against animal and microbial pests, such as against insects, mites, phytopathogenic fingi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are particularly emphasized are the increased defense of the plants against insects by toxins formed in the plants, in particular those formed by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names. YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant varieties having these or still-to-be-developed genetic traits, which plants will be developed and/or marketed in the future.

The plants listed can be treated according to the invention in a particularly advantageous manner with the active compound mixtures. The preferred ranges stated above for the mixtures also apply to the treatment of these plants. Particular emphasis is given to the treatment of plants with the mixtures specifically mentioned in the present text.

### USE EXAMPLES

### Preparation of the 20 WS Formulation and Subsequent Seed Dressing

In an agate mortar, the amount of safener and the amount of active compound required to prepare a 20 WS formulation are dissolved in acetone, and the appropriate amount of formulation without active compounds (which is actually used to prepare Gaucho 70 WS) is added. The mixture is allowed to dry until only a small amount of residual moisture can be detected. Using a spatula, the substance is carefully detached from the side of the mortar, and the substance is comminuted in the mortar until it has dried. An amount of the laboratory formulation thus prepared which is appropriate for the amount of seed to be dressed is filled into beakers of a size big enough so that, during dressing, they are at most one third filled with seed. A sufficient amount of water (depending on the properties of the seed surface) is then added. The seed is then filled into these beakers containing formulation and water and dressed on a test tube shaker with the aid of a spatula or glass rod. Once the formulation is distributed on the seed as uniformly as possible, the seed is allowed to dry in a fume hood.

### Practice of the Test in Seed Trays

3 l trays made of plastic (20×20×5 cm) are filled with sandy loam. Using a punch, the soil is firmed such that the deposition depth required for the crop in question is achieved. 20 seeds/seed tray are placed at regular intervals with the aid of a pair of tweezers impressed into the soil using the abovementioned punch. The test containers are placed in a greenhouse and, using the punch, the surface is once again firmed gently. In addition to the test substances, an untreated control is tested, too. Per variant, there are at least 2 trays. The trays are watered and covered with a film until the plants have emerged. After emergence, the trays are watered 2 times a day. Evaluation is carried out by counting the plants that have emerged and by assessing damage, (in %) over an interval of 5-14 days after sowing in comparison to the untreated control.

Results for the greenhouse trials with safener after seed dressing:

### Example I-1-1

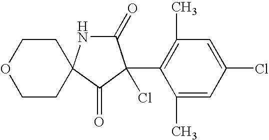

known from WO 03/029213, Ex. No. I-1-c-11

TABLE A

| | | Maize | |
|---|---|---|---|
| | | evaluation after 14^{d} | |
| | Application rate | plants that | |
| | g of ai/kg of seed | have emerged in % | % damage |
| Example I-1-1 | 2 | 71 | 95 |
| a) Example I-1-1 + | 2 + 1 | 100 | 60 |
| II-e-5 | | | |
| II-e-5 | 1 | 100 | 0 |
| b) Example I-1-1 + | 2 + 1 | 96 | 80 |
| Isoxadifen-ethyl | | | |
| Isoxadifen-ethyl | 1 | 96 | 0 |

TABLE B

| | | Summer barley | |
|---|---|---|---|
| | | evaluation after 14^{d} | |
| | Application rate | plants that have | |
| | g of ai/kg of seed | emerged in % | % damage |
| Example I-1-1 | 2 | 0 | 100 |
| Example I-1-1 + | 2 + 1 | 69 | 0 |
| Mefenpyr-diethyl | | | |
| Mefenpyr-diethyl | 1 | 75 | 0 |

TABLE C

| | | Winter barley | |
|---|---|---|---|
| | | evaluation after 14^{d} | |
| | Application rate | plants that | |
| | g of ai/kg of seed | have emerged in % | % damage |
| Example I-1-1 | 2 | 0 | 100 |
| Example I-1-1 + | 2 + 1 | 76 | 0 |
| Mefenpyr-diethyl | | | |
| Mefenpyr-diethyl | 1 | 83 | 0 |

Method: Safener Test after Spraying

### Variant a)

| | |
|---|---|
| Solvent: | 7 parts by weight of DMF |
| Emulsifier: | 2 parts by weight of alkylaryl polyglycol ether |

To produce a suitable preparation of active compound, 1 part by weight of active compound is mixed with the stated amounts of solvent and emulsifier, and the concentrate is diluted with tap water to the desired concentration. The desired amount of safener (in the case of mefenpyr-diethyl as WP 20) is mixed into the water used for dilution. Furthermore, 2 g of ai/l of rapeseed oil methyl ester 500 EW are added. Leaves of winter barley at the 2-leaf stage which are infested by the bird cherry-oat aphid (Rhopalosiphum padi) are treated with the desired active compound and safener concentrations using a spray boom, the water application rate being 300 l/ha. Per variant, the test is carried out at least twice. Evaluation is carried out after 7 d and/or 14 d by assessing the plant damage in %, where both the treated plant and new growth and the kill of the grain aphids in % compared to the untreated control are evaluated. 100% damage means that the plant has died, and 0% means no damage. 100% effect on the grain aphids means that all aphids have been killed; 0% means that none of the aphids have been killed.

### Variant b)

In variant b), the active compound is applied as an SC formulation in the desired concentrations as in variant a) in a mixture with mefenpyr-diethyl WP 20 and 2 g of ai/l rapeseed oil methyl ester 500 EW. Practice and evaluation is carried out as stated in variant a).

Results for greenhouse trials with safener after spraying against Rhopalosiphium padi on winter barley

### Example I-1-2

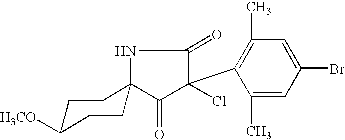

known from WO 03/029 213, Ex. I-1-a-9

TABLE D
(Variant b)

| Application rate | Kill (%) | | Damage (%) | |
|---|---|---|---|---|
| g of ai/ha | 7 d | 14 d | 7 d | 14 d |

| | | | | | |
|---|---|---|---|---|---|
| Example I-1-2 | 40 | 100 | 70 | 40 | 60 |
| Example I-1-2 + | 40 + 100 | 98 | 86 | 10 | 10 |
| Mefenpyr-diethyl | | | | | |
| Mefenpyr-diethyl | 200 | 0 | 0 | 0 | 0 |

TABLE E
(Variant b)

| | | | | Damage to new | |
|---|---|---|---|---|---|
| | Application rate | Kill (%) | | growth (%) | |
| | g of ai/ha | 7 d | 14 d | 7 d | 14 d |
| Example I-1-2 | 40 | 100 | 70 | 100 | 100 |
| Example I-1-2 + | 40 + 100 | 98 | 86 | 0 | 30 |
| Mefenpyr-diethyl | | | | | |
| Mefenpyr-diethyl | 200 | 0 | 0 | 0 | 0 |

TABLE F
(Variant b)

| | | | | Damage to new | |
|---|---|---|---|---|---|
| | Application rate | Kill (%) | | growth (%) | |
| | g of ai/ha | 7 d | 14 d | 7 d | 14 d |
| Example I-1-2 | 8 | 73 | 33 | 100 | 70 |
| Example I-1-2 + | 8 + 200 | 93 | 37 | 0 | 0 |
| Mefenpyr-diethyl | | | | | |
| Mefenpyr-diethyl | 200 | 0 | 0 | 0 | 0 |

TABLE G
(Variant a)

| | Application rate | Kill (%) | | Damage (%) | |
|---|---|---|---|---|---|
| | g of ai/ha | 7 d | 14 d | 7 d | 14 d |
| Example I-1-2 | 40 | 100 | 78 | 40 | 50 |
| Example I-1-2 + | 40 + 50 | 100 | 88 | 0 | 10 |
| Mefenpyr-diethyl | | | | | |
| Mefenpyr-diethyl | 200 | 0 | 0 | 0 | 0 |

TABLE H
(Variant a)

| | | | | Damage to new | |
|---|---|---|---|---|---|
| | Application rate | Kill (%) | | growth (%) | |
| | g of ai/ha | 7 d | 14 d | 7 d | 14 d |
| Example I-1-2 | 40 | 100 | 78 | 70 | 80 |
| Example I-1-2 + | 40 + 50 | 100 | 88 | 30 | 30 |
| Mefenpyr-diethyl | | | | | |
| Mefenpyr-diethyl | 200 | 0 | 0 | 0 | 0 |

### Formula to Calculate the Kill Rate of a Combination of Two Active Compounds

The expected activity of a given combination of two active compounds can be calculated according to S. R. Colby, Weeds 15 (1967), 20-22 as follows:

if
X is the kill rate when employing active compound A at an application rate of m g/ha or in a concentration of m ppm,
Y is the kill rate when employing active compound B at an application rate of n g/ha or in a concentration of n ppm and
E is the kill rate when using the active compounds A and B at application rates of m and n g/ha or in a concentration of m and n ppm,
   then

$$E = X + Y - \frac{X \cdot Y}{100}$$

Here, the kill rate is determined in %. 0% means a kill rate which corresponds to that of the control, whereas a kill rate of 100% means that no infection is observed.

If the actual activity exceeds the calculated value, the activity of the combination is superadditive, i.e. a synergistic effect is present. In this case, the actually observed kill rate must exceed the value calculated using the above formula for the expected kill rate (E).

### EXAMPLES OF SPRAY APPLICATION

| | |
|---|---|
| Solvent: | water |
| Adjuvant: | rapeseed oil methyl ester (0.1% of a.i./l) |

To prepare a suitable application solution, 1 part by weight of formulation is mixed with the appropriate amount of water and the adjuvant and the concentrate is diluted with water to the desired concentration.

### Example I

### Aphis gossypii Test

Cotton plants (Gossypium herbaceum) which are heavily infested by the cotton aphid (Aphis gossypii) are sprayed to runoff point with the desired concentration of the application solution.

### Example J

### Myzus persicae Test

Bell pepper plants (Capsicum sativum) which are heavily infested by the green peach-aphid (Myzus persicae) are sprayed to runoff point with the desired concentration of the application solution.

### Example K

### Metopolophium dirhodum Test

Barley plants (Hordeum vulgare) which are heavily infested by a grain aphids (Metopolophium dirhodum) are sprayed to runoff point with the desired concentration of the application solution.

After the desired period of time, the kill in % is determined. 100% means that all aphids have been killed; 0% means that none of the aphids have been killed. The determined kill rates are entered in Colby's formula.

In this test, for example, the following active compound combination in accordance with the present application shows a synergistically enhanced activity compared to the active compounds applied individually:

TABLE I
Plant-damaging insects
Aphis gossypii test

| | Concentration | | |
|---|---|---|---|
| Active compound/formulation | in ppm | | |
| | | Kill rate | |
| | | in % after 3^{d} | |
| Ex. (I-1-2) | 20 | 0 | |
| known | | | |
| Isoxadifen-ethyl WG50 | 100 | 0 | |
| known | | | |
| | | found* | calc.** |
| Ex. (I-1-2) + Isoxadifen-ethyl (1:5) | 20 + 100 | 35 | 0 |
| according to the invention | | | |
| Mefenpyr-diethyl WG15 | 100 | 0 | |
| known | | | |
| Ex. (I-1-2) + Mefenpyr-diethyl (1:5) | 20 + 100 | 55 | 0 |
| according to the invention | | | |
| Ex. (IIe-5) | 100 | 0 | |
| known | | | |
| Ex. (I-1-2) + (Ex. IIe-5) | 20 + 100 | 55 | 0 |
| according to the invention | | | |
| Cloquintocet-mexyl WP20 | 100 | 0 | |
| known | | | |
| Ex. (I-1-2) + Cloquintocet-mexyl | 20 + 100 | 55 | 0 |
| (1:5) | | | |
| according to the invention | | | |
| Fenclorim a.i. | 100 | 0 | |
| known | | | |
| Ex. (I-1-2) + Fenclorim (1:5) | 20 + 100 | 30 | 0 |
| according to the invention | | | |
| Furilazole a.i. | 100 | 0 | |
| known | | | |
| Ex. (I-1-2) + Furilazole (1:5) | 20 + 100 | 65 | 0 |
| according to the invention | | | |
| | | Kill rate | |
| | | in % after 7^{d} | |
| Ex. (I-1-1) | 20 | 20 | |
| known | | | |
| Isoxadifen-ethyl WG50 | 100 | 0 | |
| known | | | |
| | | found* | calc.** |
| Ex. (I-1-1) + Isoxadifen-ethyl (1:5) | 20 + 100 | 65 | 20 |
| according to the invention | | | |
| Mefenpyr-diethyl WG15 | 100 | 0 | |
| known | | | |
| Ex. (I-1-1) + Mefenpyr-diethyl (1:5) | 20 + 100 | 55 | 20 |
| according to the invention | | | |
| Ex. (IIe-5) | 100 | 0 | |
| known | | | |
| Ex. (I-1-1) + (Ex. IIe-5) | 20 + 100 | 65 | 20 |
| according to the invention | | | |
| Cloquintocet-mexyl WP20 | 100 | 0 | |
| known | | | |
| Ex. (I-1-1) + Cloquintocet-mexyl | 20 + 100 | 75 | 20 |
| (1:5) according to the invention | | | |
| Dichlormid a.i. | 100 | 0 | |
| known | | | |
| Ex. (I-1-1) + Dichlormid (1:5) | 20 + 100 | 55 | 20 |
| according to the invention | | | |
| Fenclorim a.i. | 100 | 0 | |
| known | | | |
| Ex. (I-1-1) + Fenclorim (1:5) | 20 + 100 | 60 | 20 |
| according to the invention | | | |

*found = activity found
**calc. = activity calculated using Colby's formula

TABLE J
Plant-damaging insects
Myzus persicae test

| | Concentration | Kill rate | |
|---|---|---|---|
| Active compound/formulation | in ppm | in % after 7^{d} | |
| Ex. (I-1-2) | 20 | 25 | |
| known | | | |
| Isoxadifen-ethyl WG50 | 100 | 0 | |
| known | | | |
| | | found* | calc.** |
| Ex. (I-1-2) + Isoxadifen-ethyl (1:5) | 20 + 100 | 85 | 25 |
| according to the invention | | | |
| Mefenpyr-diethyl WG15 | 100 | 0 | |
| known | | | |
| Ex. (I-1-2) + Mefenpyr-diethyl (1:5) | 20 + 100 | 45 | 25 |
| according to the invention | | | |
| Ex. (IIe-5) | 100 | 0 | |
| known | | | |
| Ex. (I-1-2) + (Ex. IIe-5) | 20 + 100 | 65 | 25 |
| according to the invention | | | |
| Cloquintocet-mexyl WP20 | 100 | 0 | |
| known | | | |
| Ex. (I-1-2) + Cloquintocet-mexyl | 20 + 100 | 65 | 25 |
| (1:5) according to the invention | | | |
| Dichlormid a.i. | 100 | 0 | |
| known | | | |
| Ex. (I-1-2) + Dichlormid (1:5) | 20 + 100 | 45 | 25 |
| according to the invention | | | |
| Fenclorim a.i. | 100 | 0 | |
| known | | | |
| Ex. (I-1-2) + Fenclorim (1:5) | 20 + 100 | 70 | 25 |
| according to the invention | | | |
| Furilazole a.i. | 100 | 0 | |
| known | | | |
| Ex. (I-1-2) + Furilazole (1:5) | 20 + 100 | 85 | 25 |
| according to the invention | | | |

*found = activity found,
**calc. = activity calculated using Colby's formula

TABLE K
Plant-damaging insects
Metopolophium dirhodum test

| | Concentration | Kill rate | |
|---|---|---|---|
| Active compound/formulation | in ppm | in % after 7^{d} | |
| Ex. (I-1-2) | 20 | 45 | |
| known | | | |
| Isoxadifen-ethyl WG50 | 100 | 0 | |
| known | | | |
| | | found* | calc.** |
| Ex. (I-1-2) + Isoxadifen-ethyl (1:5) | 20 + 100 | 65 | 45 |
| according to the invention | | | |
| Mefenpyrdiethyl WG15 | 100 | 0 | |
| known | | | |
| Ex. (I-1-2) + Mefenpyr-diethyl (1:5) | 20 + 100 | 70 | 45 |
| according to the invention | | | |
| Ex. (IIe-5) | 100 | 0 | |
| known | | | |
| Ex. (I-1-2) + (Ex. IIe-5) | 20 + 100 | 75 | 45 |
| according to the invention | | | |
| Cloquintocet-mexyl a.i. | 100 | 0 | |
| known | | | |
| Ex. (I-1-2) + Cloquintocet-mexyl | 20 + 100 | 65 | 45 |
| (1:5) according to the invention | | | |
| Furilazole a.i. | 100 | 0 | |
| known | | | |
| Ex. (I-1-2) + Furilazole (1:5) | 20 + 100 | 85 | 45 |
| according to the invention | | | |

*found = activity found
**calc. = activity calculated using Colby's formula

### Example L

### Critical Concentration Test Soil Insects

### Treatment of Transgenic Plants

| | |
|---|---|
| Test insect: | Diabrotica balteata-larvae in soil |
| Solvent: | 7 parts by weight of acetone |
| Emulsifier: | 1 part by weight of alkylaryl polyglycol ether |

To produce a suitable preparation of active compound, 1 part by weight of active compound is mixed with the stated amount of solvent, the stated amount of emulsifier is added and the concentrate is diluted with water to the desired concentration.

The preparation of active compound is poured onto the soil. Here, the concentration of active compound in the preparation is virtually irrelevant; only the amount by weight of active compound per volume unit of soil, which is stated in ppm (mg/l), matters. 0.25 l pots are filled with the soil and allowed to stand at 20° C.

Immediately after preparation, 5 pre-germinated maize corns of the cultivar YIELD GUARD (trade mark of Monsanto Comp., USA) are placed into each pot. After 2 days, the corresponding test insects are placed into the treated soil. After a further 7 days, the efficacy of the active compound is determined by counting the maize plants that have emerged (1 plant=20% efficacy).

### Example M Heliothis virescens Test-Treatment of Transgenic Plants

| | |
|---|---|
| Solvent: | 7 parts by weight of acetone |
| Emulsifier: | 1 part by weight of alkylaryl polyglycol ether |

To produce a suitable preparation of active compound, 1 part by weight of active compound is mixed with the stated amount of solvent and the stated amount of emulsifier, and the concentrate is diluted with water to the desired concentration.

Soya bean shoots (Glycine max) of the cultivar Roundup Ready (trade mark of Monsanto Comp., USA) are treated by being dipped into the preparation of active compound of the desired concentration and are populated with the tobacco budworm Heliothis virescens while the leaves are still moist.

After the desired period of time, the kill of the insects is determined.

1. Use of a composition comprising an effective amount of an active compound combination comprising
(a) at least one compound of the formula (I) 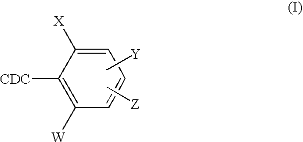
in which
W and Z independently of one another represent hydrogen, halogen, alkyl, alkenyl, alkynyl, alkoxy, alkenyloxy, haloalkyl, haloalkoxy, haloalkenyloxy, nitro or cyano,
X represents halogen, alkyl, alkenyl, alkynyl, alkoxy, alkenyloxy, alkylthio, alkylsulphinyl, alkylsulphonyl, haloalkyl, haloalkoxy, haloalkenyloxy, nitro or cyano,
Y represents hydrogen, halogen, alkyl, haloalkyl, haloalkoxy, nitro, cyano or represents optionally substituted phenyl or hetaryl,
CDC represents one of the groups 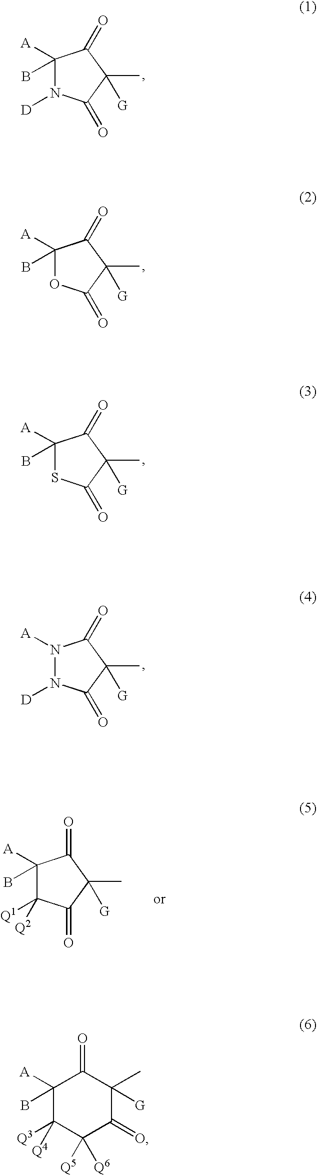
in which
A represents hydrogen, in each case optionally halogen-substituted alkyl, alkenyl, alkoxyalkyl, alkylthioalkyl, saturated or unsaturated, optionally substituted cycloalkyl in which optionally at least one ring atom is replaced by a heteroatom, or in each case optionally halogen-, alkyl-, haloalkyl-, alkoxy-, haloalkoxy-, cyano- or nitro-substituted aryl, arylalkyl or hetaryl,
B represents hydrogen, alkyl or alkoxyalkyl, or
A and B together with the carbon atom to which they are attached represent a saturated or unsaturated, unsubstituted or substituted cycle which optionally contains at least one heteroatom,
D represents hydrogen or an optionally substituted radical from the group consisting of alkyl, alkenyl, alkynyl, alkoxyalkyl, saturated or unsaturated cycloalkyl in which optionally one or more ring members are replaced by heteroatoms, arylalkyl, aryl, hetarylalkyl or hetaryl or
A and D together with the atoms to which they are attached represent a saturated or unsaturated cycle which is unsubstituted or substituted in the A,D moiety and optionally contains at least one heteroatom, or
A and Q¹ together represent alkanediyl or alkenediyl optionally substituted by hydroxyl or by in each case optionally substituted alkyl, alkoxy, alkylthio, cycloalkyl, benzyloxy or aryl, or
Q¹ represents hydrogen or alkyl,
Q², Q⁴, Q⁵ and Q⁶ independently of one another represent hydrogen or alkyl,
Q³ represents hydrogen, alkyl, alkoxyalkyl, alkylthioalkyl, optionally substituted cycloalkyl (in which optionally one methylene group is replaced by oxygen or sulphur) or optionally substituted phenyl, or
Q³ and Q⁴ together with the carbon atom to which they are attached represent a saturated or unsaturated, unsubstituted or substituted cycle which optionally contains a heteroatom,
G represents halogen or nitro,
including all isomeric forms,
and
(b) at least one crop plant compatibility-improving compound from the following group of compounds:
4-dichloroacetyl-1-oxa-4-azaspiro[4.5]decane (AD-67, MON-4660), 1-dichloroacetyl-hexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), 1-methylhexyl 5-chloroquinolin-8-oxyacetate (cloquintocet-mexyl—cf. also related compounds in EP-A-86750, EP-A-94349, EP-A-191736, EP-A-492366), 3-(2-chlorobenzyl)-1-(1-methyl-1-phenylethyl)urea (cumyluron), α-(cyanomethoximino)-phenylacetonitrile (cyometrinil), 2,4-dichlorophenoxyacetic acid (2,4-D), 4-(2,4-dichloro-phenoxy)butyric acid (2,4-DB), 1-(1-methyl-1-phenylethyl)-3-(4-methyl-phenyl)urea (daimiuron, dymron), 3,6-dichloro-2-methoxybenzoic acid (dicamba), S-1-methyl-1-phenylethyl piperidine-1-thiocarboxylate (dimepiperate), 2,2-dichloro-N-(2-oxo-2-(2-propenylamino)ethyl) N-(2-propenyl)acetamide (DKA-24), 2,2-dichlor-N,N-di-2-propenyl-acetamide (dichlormid), 4,6-dichloro-2-phenylpyrimidine (fenclorim), ethyl 1-(2,4-dichlorophenyl)-5-trichloromethyl-1H-1,2,4-triazole-3-carboxylate (fenchlorazole-ethyl—cf. also related compounds in EP-A-174562 and EP-A-346620), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl 4,5-dihydro-5,5-diphenyl-3-isoxazolecarboxylate (isoxadifen-ethyl—cf. also related compounds in WO-A-95/07897), 1-(ethoxycarbonyl)ethyl-3,6-dichloro-2-methoxybenzoate (lactidichlor), (4-chloro-o-tolyloxy)acetic acid (MCPA), 2-(4-chloro-o-tolyloxy)propionic acid (mecoprop), diethyl 1-(2,4-dichloro-phenyl)-4,5-dihydro-5-methyl-1H-pyrazole-3,5-dicarboxylate (mefenpyr-diethyl—cf. also related compounds in WO-A-91/07874), 2-dichloromethyl-2-methyl-1,3-dioxolane (MG-191), 2-propenyl-1-oxa-4-azaspiro[4.5]decane 4-carbodithioate (MG-838), 1,8-naphthalic anhydride, α-(1,3-dioxolan-2-yl-methoximino)phenylacetonitrile (oxabetrinil), 2,2-chloro-N-1,3-dioxolan-2-ylmethyl)N-(2-propenyl)acetamide (PG-1292), 3-dichloroacetyl-2,2-dimethyloxazolidine (R-28725), 3-dichloroacetyl-2,2,5-trimethyloxazolidine (R-29148), 4-(4-chloro-o-tolyl)butic acid, 4-(4-chlorophenoxy)butyric acid, diphenylmethoxyacetic acid, methyl diphenylmethoxyacetate, ethyl diphenylmethoxyacetate, methyl 1-(2-chlorophenyl)-5-phenyl-1H-pyrazole-3-carboxylate, ethyl 1-(2,4-dichlorophenyl)-5-methyl-1H-pyrazole-3-carboxylate, ethyl 1-(2,4-dichlorophenyl)-5-isopropyl-1H-pyrazole-3-carboxylate, ethyl 1-(2,4-dichlorophenyl)-5-(1,1-dimethylethyl)-1H-pyrazole-3-carboxylate, ethyl 1-(2,4-dichlorophenyl)-5-phenyl-1H-pyrazole-3-carboxylate (cf. also related compounds in EP-A-269806 and EP-A-333131), ethyl 5-(2,4-dichlorobenzyl)-2-isoxazoline-3-carboxylate, ethyl 5-phenyl-2-isoxazoline-3-carboxylate, ethyl 5-(4-fluorophenyl)-5-phenyl-2-isoxazoline-3-carboxylate (cf. also related compounds in WO-A-91/08202), 1,3-dimethylbut-1-yl 5-chloroquinolin-8-oxyacetate, 4-allyloxybutyl 5-chloroquinolin-8-oxyacetate, 1-allyloxyprop-2-yl 5-chloroquinolin-8-oxyacetate; methyl 5-chloroquinoxalin-8-oxyacetate, ethyl 5-chloroquinolin-8-oxyacetate, allyl 5-chloroquinoxalin-8-oxyacetate, 2-oxoprop-1-yl-5-chloroquinolin-8-oxyacetate, diethyl 5-chloroquinolin-8-oxymalonate, diallyl 5-chloroquinoxalin-8-oxymalonate, diethyl 5-chloroquinolin-8-oxymalonate (cf. also related compounds in EP-A-582198), 4-carboxy-chroman-4-ylacetic acid (AC-304415, cf. EP-A-613618), 4-chlorophenoxyacetic acid, 3,3′-dimethyl-4-methoxybenzophenone, 1-bromo-4-chloromethylsulphonylbenzene, 1-[4-(N-2-methoxybenzoylsulphamoyl)phenyl]-3-methylurea (alias N-(2-methoxybenzoyl)-4-[(methylaminocarbonyl)amino]benzenesulphonamide), 1-[4-N-2-methoxybenzoylsulphamoyl)phenyl]-3,3-dimethylurea, 1-[4-(N-4,5-dimethylbenzoylsulphamoyl)phenyl]-3-methylurea, 1-[4-(N-naphthylsulphamoyl)phenyl]-3,3-dimethylurea, N-(2-methoxy-5-methylbenzoyl)-4-cyclopropylaminocarbonyl)benzenesulphonamide,
and/or one of the following compounds (defined by general formulae)
of the general formula (IIa) 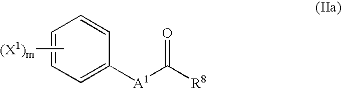
or of the general formula (IIb) 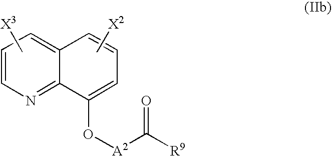
or of the formula (IIc) 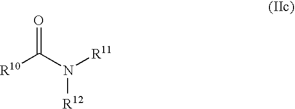
where
m represents a number 0, 1, 2, 3, 4 or 5,
A¹ represents one of the divalent heterocyclic groups outlined hereinbelow, 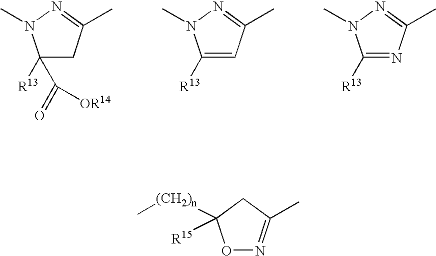
n represents a number 0, 1, 2, 3, 4 or 5,
A² represents alkanediyl having 1 or 2 carbon atoms which is optionally substituted by C₁-C₄-alkyl and/or C₁-C₄-alkoxycarbonyl and/or C₁-C₄-alkenyloxy-carbonyl,
R⁸ represents hydroxyl, mercapto, amino, C₁-C₇-alkoxy, C₁-C₆-alkenyloxy, C₁-C₆-alkenyloxy-C₁-C₆-alkoxy, C₁-C₆-alkylthio, C₁-C₆-alkylamino or di-(C₁-C₄-alkyl)amino,
R⁹ represents hydroxyl, mercapto, amino, C₁-C₆-alkoxy, C₁-C₆-alkylthio, C₁-C₆-alkylamino or di-C₁-C₄-alkyl)amino,
R¹⁰ represents C₁-C₄-alkyl which is optionally substituted in each case by fluorine, chlorine and/or bromine,
R¹¹ represents hydrogen, or represents C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, each of which is optionally substituted by fluorine, chlorine and/or bromine, or represents phenyl which is optionally substituted by fluorine, chlorine and/or bromine or C₁-C₄-alkyl,
R¹² represents hydrogen, or represents C₁-C₆-alkyl, C₂-C₆-alkenyl or C₂-C₆-alkynyl, C₁-C₄-alkoxy-C₁-C₄-alkyl, dioxolanyl-C₁-C₄-alkyl, furyl, furyl-C₁-C₄-alkyl, thienyl, thiazolyl, piperidinyl, each of which is optionally substituted by fluorine, chlorine and/or bromine, or represents phenyl which is optionally substituted by fluorine, chlorine and/or bromine or C₁-C₄-alkyl, or R¹¹ and R¹² together represent C₃-C₆-alkanediyl or C₂-C₅-oxaalianediyl, each of which is optionally substituted by C₁-C₄-alkyl, phenyl, furyl, a fused benzene ring or by two substituents which, together with the C atom to which they are bonded, form a 5- or 6-membered carbocycle,
R¹³ represents hydrogen, cyano, halogen, or represents C₁-C₄-alkyl, C₃-C₆-cycloalkyl or phenyl, each of which is optionally substituted by fluorine, chlorine and/or bromine,
R¹⁴ represents hydrogen, or represents C₁-C₆-alkyl, C₃-C₆-cycloalkyl or tri(C₁-C₄-alkyl)silyl, optionally substituted by hydroxyl, cyano, halogen or C₁-C₄-alkoxy,
R¹⁵ represents hydrogen, cyano, halogen, or represents C₁-C₄-alkyl, C₃-C₆-cycloalkyl or phenyl, each of which is optionally substituted by fluorine, chlorine and/or bromine,
X¹ represents nitro, cyano, halogen, C₁-C₄-alkyl, C₁-C₄-haloalkyl, C₁-C₄-alkoxy or C₁-C₄-haloalkoxy,
X² represents hydrogen, cyano, nitro, halogen, C₁-C₄-alkyl, C₁-C₄-haloalkyl, C₁-C₄-alkoxy or C₁-C₄-haloalkoxy,
X³ represents hydrogen, cyano, nitro, halogen, C₁-C₄-alkyl, C₁-C₄-haloalkyl, C₁-C₄-alkoxy or C₁-C₄-haloalkoxy;
and/or the following compounds (defined by general formulae)
of the general formula (IId) 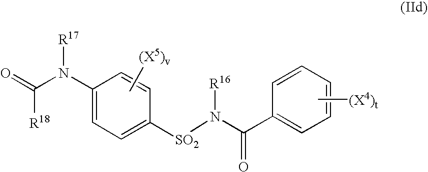
or of the general formula (IIe) 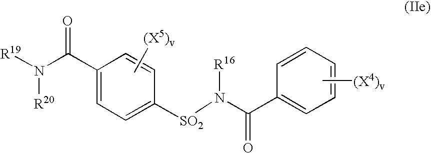
where
t represents a number 0, 1, 2, 3, 4 or 5,
v represents a number 0, 1, 2, 3, 4 or 5,
R¹⁶ represents hydrogen or C₁-C₄-alkyl,
R¹⁷ represents hydrogen or C₁-C₄-alkyl,
R¹⁸ represents hydrogen, or represents C₁-C₆-alkyl, C₁-C₆-alkoxy, C₁-C₆-alkylthio, C₁-C₆-alkylamino or di-(C₁-C₄-alkyl)amino, each of which is optionally substituted by cyano, halogen or C₁-C₄-alkoxy, or represents C₃-C₆-cycloalkyl, C₃-C₆-cycloalkyloxy, C₃-C₆-cycloalkylthio or C₃-C₆-cycloalkylamino, each of which is optionally substituted by cyano, halogen or C₁-C₄-alkyl,
R¹⁹ represents hydrogen, or represents C₁-C₆-alkyl which is optionally substituted by cyano, hydroxyl, halogen or C₁-C₄-alkoxy, or represents C₃-C₆-alkenyl or C₃-C₆-alkynyl, each of which is optionally substituted by cyano or halogen, or represents C₃-C₆-cycloalkyl which is optionally substituted by cyano, halogen or C₁-C₄-alkyl,
R²⁰ represents hydrogen, or represents C₁-C₆-alkyl which is optionally substituted by cyano, hydroxyl, halogen or C₁-C₄-alkoxy, or represents —C₃-C₆-alkenyl or C₃-C₆-alkynyl, each of which is optionally substituted by cyano or halogen, or represents C₃-C₆-cycloalkyl which is optionally substituted by cyano, halogen or C₁-C₄-alkyl, or represents phenyl which is optionally substituted by nitro, cyano, halogen, C₁-C₄-alkyl, C₁-C₄-haloalkyl, C₁-C₄-alkoxy or C₁-C₄-haloalkoxy, or together with R¹⁹ represents C₂-C₆-alkanediyl or C₂-C₅-oxaalkanediyl, each of which is optionally substituted by C₁-C₄-alkyl,
X⁴ represents nitro, cyano, carboxyl, carbamoyl, formyl, sulphamoyl, hydroxyl, amino, halogen, C₁-C₄-alkyl, C₁-C₄-haloalkyl, C₁-C₄-alkoxy or C₁-C₄-haloalkoxy, and
X⁵ represents nitro, cyano, carboxyl, carbamoyl, formyl, sulphamoyl, hydroxyl, amino, halogen, C₁-C₄-alkyl, C₁-C₄-haloalkyl, C₁-C₄-alkoxy or C₁-C₄-haloalkoxy,
for controlling insects and/or arachnids.

2. Use of a composition according to claim 1 for controlling insects and/or arachnids, which composition comprises compounds of the formula (I) in which
W and Z independently of one another represent hydrogen, halogen, C₁-C₆-alkyl, C₁-C₆-haloalkyl or C₁-C₆-alkoxy,
X represents halogen, C₁-C₆-alkyl, C₂-C₆-alkenyl, C₂-C₆-alkynyl, C₁-C₆-haloalkyl, C₁-C₆-alkoxy, C₃-C₆-alkenyloxy, C₁-C₆-haloalkoxy, C₃-C₆-haloalkenyloxy, nitro or cyano,
Y represents hydrogen, halogen, C₁-C₄-alkyl, C₁-C₂-haloalkyl, C₁-C₂-haloalkoxy, cyano or one of the radicals 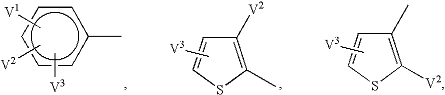
in which
V¹ represents hydrogen, halogen, C₁-C₁₂-alkyl, C₁-C₆-alkoxy, C₁-C₄-haloalkyl, C₁-C₄-haloalkoxy, nitro or cyano,
V² and V³ independently of one another represent hydrogen, halogen, C₁-C₆-alkyl, C₁-C₆-alkoxy, C₁-C₄-haloalkyl or C₁-C₄-haloalkoxy,
CDC represents one of the groups 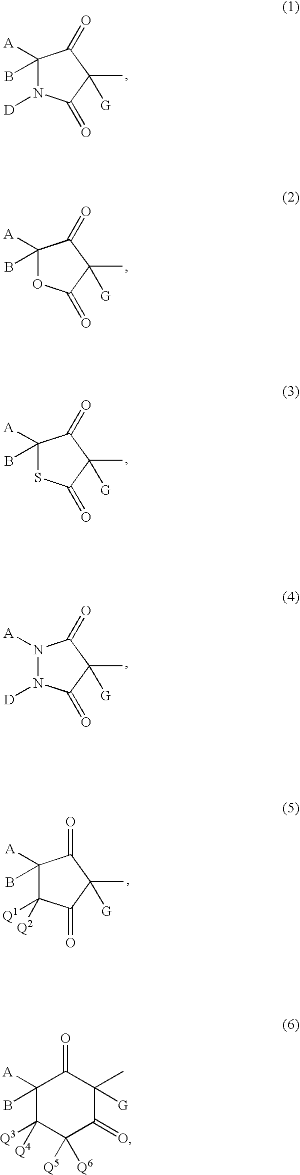
A represents hydrogen or in each case optionally halogen-substituted C₁-C₁₂-alkyl, C₃-C₈-alkenyl, C₁-C₁₀-alkoxy-C₁-C₈-alkyl, C₁-C₁₀-alylthio-C₁-C₆-alkyl, optionally halogen-, C₁-C₆-alkyl- or C₁-C₆-alkoxy-substituted C₃-C₈-cycloalkyl in which optionally one or two not directly adjacent ring members are replaced by oxygen and/or sulphur or represents in each case optionally halogen-, C₁-C₆-alkyl-, C₁-C₆-haloalkyl-, C₁-C₆-alkoxy-, C₁-C₆ haloalkoxy-, cyano- or nitro-substituted phenyl or phenyl-C₁-C₆-alkyl,
B represents hydrogen, C₁-C₁₂-alkyl or C₁-C₈-alkoxy-C₁-C₆-alkyl, or
A, B and the carbon atom to which they are attached represent saturated C₃-C₁₀-cycloalkyl or unsaturated C₅-C₁₀-cycloalkyl in which optionally one ring member is replaced by oxygen or sulphur and which are optionally mono- or disubstituted by C₁-C₈-alkyl, C₃-C₁₀-cycloalkyl, C₁-C₈-haloalkyl, C₁-C₈-alkoxy, C₁-C₈-alkylthio, halogen or phenyl, or
A, B and the carbon atom to which they are attached represent C₅-C₆-cycloalkyl which is substituted by an alkylenediyl group which is optionally substituted by C₁-C₄-alkyl and which optionally contains one or two not directly adjacent oxygen and/or sulphur atoms, or by an alkylenedioxyl group or by an alkylenedithioyl group which, together with the carbon atom to which it is attached, forms a further five- to eight membered ring, or
A, B and the carbon atom to which they are attached represent C₃-C₈-cycloalkyl or C₅-C₈-cycloalkenyl in which two substituents together with the carbon atoms to which they are attached represent in each case optionally C₁-C₆-alkyl-, C₁-C₆-alkoxy- or halogen-substituted C₂-C₆-alkanediyl, C₂-C₆-alkenediyl or C₄-C₆-alkanedienediyl in which optionally one methylene group is replaced by oxygen or sulphur,
D represents hydrogen, represents in each case optionally halogen-substituted C₁-C₁₂-alkyl, C₃-C₈-alkenyl, C₃-C₈-alkynyl, C₁-C₁₀-alkoxy-C₂-C₈-alkyl, optionally halogen-, C₁-C₄-alkyl-, C₁-C₄-alkoxy- or C₁-C₄-haloalkyl-substituted C₃-C₆-cycloalkyl in which optionally one ring member is replaced by oxygen or sulphur or in each case optionally halogen-, C₁-C₆-alkyl-, C₁-C₆-haloalkyl-, C₁-C₆-alkoxy-, C₁-C₆-haloalkoxy-, cyano- or nitro-substituted phenyl or phenyl-C₁-C₆-alkyl,
A and D together represent in each case optionally substituted C₃-C₆-alkanediyl or C₃-C₆-alkenediyl in which optionally one methylene group is replaced by a carbonyl group, oxygen or sulphur,
suitable substituents being in each case:
halogen, hydroxyl, mercapto or in each case optionally halogen-substituted C₁-C₁₀-allyl or C₁-C₆-alkoxy, or a further C₃-C₆-alkanediyl grouping, C₃-C₆-alkenediyl grouping or a butadienyl grouping which is optionally substituted by C₁-C₆-alkyl or in which optionally two adjacent substituents together with the carbon atoms to which they are attached form a further saturated or unsaturated cycle having 5 or 6 ring atoms (in the case of the compound of the formula (I-1), A and D together with the atoms to which they are attached then represent, for example, the groups AD-1 to AD-10 mentioned below) which may contain oxygen or sulphur,
A and Q¹ together represent C₃-C₆-alkanediyl or C₄-C₆-alkenediyl, each of which is optionally mono- or disubstituted by identical or different substituents from the group consisting of halogen, of C₁-C₁₀-alkyl, C₁-C₆-alkoxy, C₁-C₆-alkylthio, C₃-C₇-cycloalkyl, each of which is optionally mono- to trisubstituted by identical or different halogen, and of benzyloxy and phenyl, each of which is optionally mono- to trisubstituted by identical or different substituents from the group consisting of halogen, C₁-C₆-alkyl and C₁-C₆-alkoxy, which C₃-C₆-alkanediyl or C₄-C₆-alkenediyl is furthermore-bridged by a C₁-C₂-alkanediyl group or by an oxygen atom, or
Q¹ represents hydrogen or C₁-C₄-alkyl,
Q², Q⁴, Q⁵ and Q⁶ independently of one another represent hydrogen or C₁-C₄-alkyl,
Q³ represents hydrogen, C₁-C₆-alkyl, C₁-C₆-alkoxy-C₁-C₂-alkyl, C₁-C₆-alkylthio-C₁-C₂-alkyl, optionally halogen-, C₁-C₄-alkyl- or C₁-C₄-alkoxy-substituted C₃-C₈-cycloalkyl in which optionally one methylene group is replaced by oxygen or sulphur or represents optionally halogen-, C₁-C₄-alkyl-, C₁-C₄-alkoxy-, C₁-C₂-haloalkyl-, C₁-C₂-haloalkoxy-, cyano- or nitro-substituted phenyl, or
Q³ and Q⁴ together with the carbon atom to which they are attached represent an optionally C₁-C₄-alkyl-, C₁-C₄-alkoxy- or C₁-C₂-haloalkyl-substituted C₃-C₇-ring in which optionally one ring member is replaced by oxygen or sulphur,
G represents chlorine, bromine or nitro.

3. Use of a composition according to claim 1 for controlling insects and/or arachnids, which composition comprises compounds of the formula (I) in which
W and Z independently of one another represent hydrogen; chlorine, bromine, C₁-C₃-alkyl or C₁-C₃-alkoxy,
X represents chlorine, bromine, C₁-C₄-alkyl, C₁-C₄-alkoxy, C₁-C₃-haloalkyl, C₁-C₃-haloalkoxy or cyano,
Y represents hydrogen, chlorine, bromine, C₁-C₂-alkyl, trifluoromethyl or represents the radical 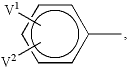
V¹ represents hydrogen, fluorine, chlorine, bromine, C₁-C₆-alkyl, C₁-C₄-alkoxy, C₁-C₂-haloalkyl, C₁-C₂-haloalkoxy, nitro or cyano,
V² represents hydrogen, fluorine, chlorine, bromine, C₁-C₄-alkyl, C₁-C₄-alkoxy, C₁-C₂-haloalkyl or C₁-C₂-haloalkoxy,
CDC represents one of the groups 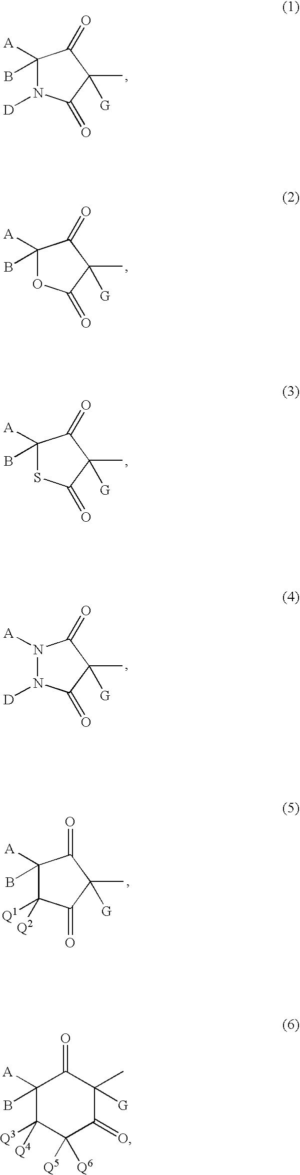
A represents, hydrogen, represents C₁-C₆-alkyl, C₁-C₄-alkoxy-C₁-C₂-alkyl, each of which is optionally mono- to trisubstituted by fluorine or chlorine, or represents C₃-C₇-cycloalkyl which is optionally mono- or disubstituted by fluorine, chlorine, C₁-C₂-alkyl or C₁-C₂-alkoxy,
B represents hydrogen or C₁-C₆-alkyl, or
A, B and the carbon atom to which they are attached represent saturated C₃-C₇-cycloalkyl in which optionally one ring member is replaced by oxygen or sulphur and which is optionally monosubstituted by C₁-C₄-alkyl, C₁-C₂-haloalkyl or C₁-C₄-alkoxy, with the proviso that Q³ then represents hydrogen or methyl, or;
A, B and the carbon atom to which they are attached represent C₅-C₆-cycloalkyl which is substituted by an alkylenediyl group which optionally contains one or two not directly adjacent oxygen or sulphur atoms and which is optionally substituted by methyl or ethyl, or by an alkylenedioxyl group, which, together with the carbon atom to which it is attached, forms a further five- or six-membered ring, with the proviso that Q³ then represents hydrogen or methyl, or
A, B and the carbon atom to which they are attached represent C₃-C₆-cycloalkyl or C₅-C₆-cycloalkenyl in which two substituents together with the carbon atoms to which they are attached represent C₂-C₄-alkanediyl, C₂-C₄-alkenediyl, where optionally one methylene group is replaced by oxygen, or butadienediyl, each of which is optionally monosubstituted by methyl or methoxy, with the proviso that Q³ then represents hydrogen or methyl,
D represents hydrogen, represents C₁-C₆-alkyl, C₃-C₆-alkenyl, C₁-C₄-alkoxy-C₂-C₃-alkyl, each of which is optionally mono to trisubstituted by fluorine or chlorine, represents C₃-C₇-cycloalkyl which is optionally monosubstituted by C₁-C₂-alkyl, C₁-C₂-alkoxy or trifluoromethyl and in which optionally one methylene group is replaced by oxygen or sulphur or (but not in the case of the compounds of the formula (I-1)) represents phenyl, pyridyl or benzyl, each of which is optionally mono- or disubstituted by fluorine, chlorine, bromine, C₁-C₄-alkyl, C₁-C₂-haloalkyl, C₁-C₄-alkoxy or C₁-C₂-haloalkoxy, or
A and D together represent optionally substituted C₃-C₅-alkanediyl in which one methylene group may be replaced by oxygen or sulphur, possible substituents being C₁-C₂-alkyl, or
A and D (in the case of the compounds of the formula (I-1)) together with the atoms to which they are attached represent one of the groups AD-1 to AD-10: 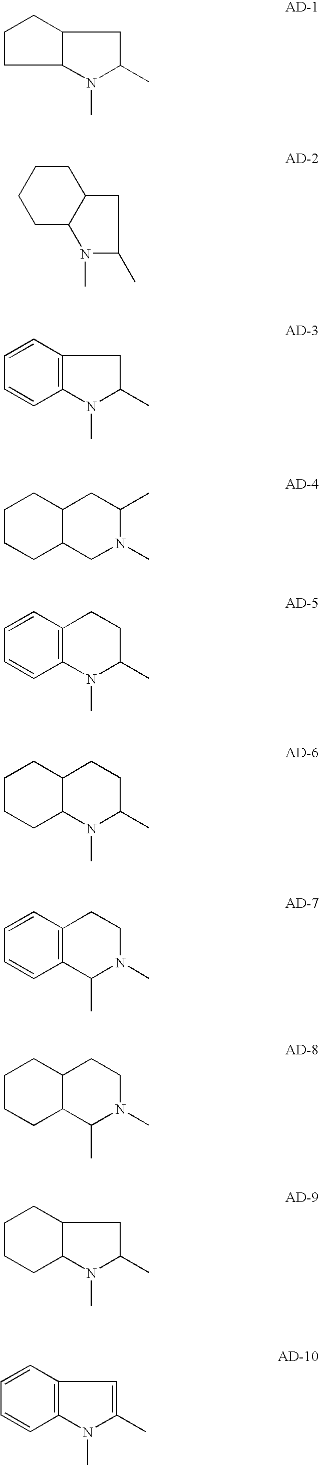
A and Q¹ together represent C₃-C₄-alkanediyl or C₃-C₄-alkenediyl, each of which is optionally mono- or disubstituted by identical or different substituents from the group consisting of C₁-C₂-alkyl and C₁-C₂-alkoxy, or
Q¹ represents hydrogen,
Q² represents hydrogen,
Q⁴, Q⁵ and Q⁶ independently of one another represent hydrogen or C₁-C₂-alkyl,
Q³ represents hydrogen, C₁-C₄-alkyl, C₁-C₄-alkoxy-C₁-C₂-alkyl, C₁-C₄-alkylthio-C₁-C₂-alkyl or optionally methyl- or methoxy-substituted C₃-C₆-cycloalkyl in which optionally one methylene group is replaced by oxygen or sulphur, or
Q³ and Q⁴ together with the carbon to which they are attached represent a saturated C₅-C₆-ring which is optionally mono- or disubstituted by C₁-C₄-alkyl or C₁-C₄-alkoxy and in which optionally one ring member is replaced by oxygen or sulphur,
with the proviso that A then represents hydrogen or methyl,
G represents chlorine or nitro.

4. Use of a composition according to claim 1 for controlling insects and/or arachnids, which composition comprises compounds of the formula (I) in which
W represents hydrogen, chlorine, bromine, methyl, ethyl, methoxy or ethoxy,
X represents chlorine, bromine, methyl, ethyl, propyl, methoxy, ethoxy, trifluoromethyl, difluoromethoxy, trifluoromethoxy or cyano,
Y represents hydrogen, chlorine, bromine, methyl, trifluoromethyl or represents the radical 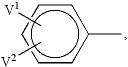
V¹ represents hydrogen, fluorine, chlorine, bromine, methyl, ethyl, tert-butyl, methoxy, trifluoromethyl or trifluoromethoxy,
V² represents hydrogen, fluorine, chlorine, methyl, methoxy or trifluoromethyl,
Z represents hydrogen, chlorine, bromine, methyl, ethyl, methoxy or ethoxy,
CDC represents one of the groups 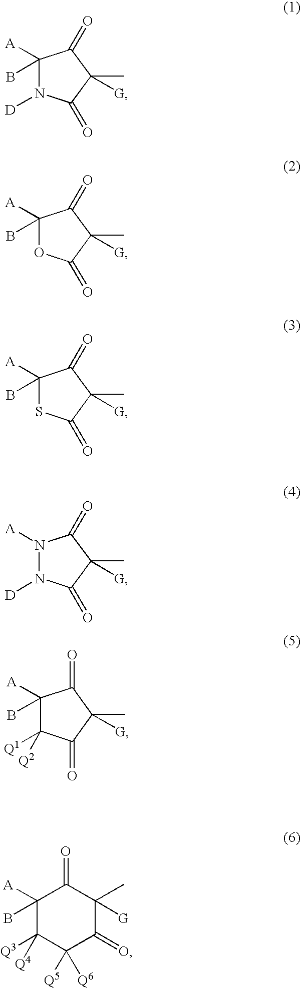
A represents hydrogen, represents C₁-C₄-alkyl or C₁-C₂-alkoxy-C₁-C₂-alkyl, each of which is optionally mono- to trisubstituted by fluorine, or represents C₃-C₆-cycloalkyl which is optionally monosubstituted by fluorine, methyl or methoxy,
B represents hydrogen, methyl or ethyl, or
A, B and the carbon atom to which they are attached represent saturated C₅-C₆-cycloalkyl in which optionally one ring member is replaced by oxygen and which is optionally monosubstituted by methyl, trifluoromethyl, methoxy, ethoxy, propoxy, butoxy or isobutoxy, with the proviso that Q³ then represents hydrogen, or
A, B and the carbon atom to which they are attached represent C₅-C₆-cycloalkyl which is substituted by an alkylenedioxyl group which contains two not directly adjacent oxygen atoms, with the proviso that Q³ then represents hydrogen,
D represents hydrogen, represents C₁-C₄-alkyl, C₃-C₄-alkenyl, C₁-C₂-alkoxy-C₂-C₃-alkyl or C₃-C₆-cycloalkyl in which optionally one methylene group is replaced by oxygen or sulphur, each of which radicals is optionally mono- to trisubstituted by fluorine, or (but not in the case of the compounds of the formula (I-1)) represents phenyl or pyridyl, each of which is optionally mono- or disubstituted by fluorine, chlorine, bromine, methyl, ethyl, n-propyl, isopropyl, methoxy, ethoxy, trifluoromethyl or trifluoromethoxy,
or
A and D together represent optionally substituted C₃-C₅-alkanediyl in which optionally one carbon atom is replaced by oxygen or sulphur and which is optionally mono- or disubstituted by methyl, or
A and D (in the case of the compounds of the formula (I-1)) together with the atoms to which they are attached represent the group: 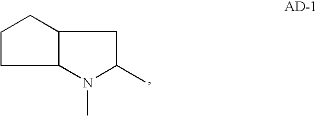
A and Q¹ together represent C₃-C₄-alkanediyl which is optionally mono- or disubstituted by methyl or methoxy or
Q¹ represents hydrogen,
Q² represents hydrogen,
Q⁴, Q⁵ and Q⁶ independently of one another represent hydrogen or methyl,
Q³ represents hydrogen, methyl, ethyl or C₃-C₆-cycloalkyl, or
Q³ and Q⁴ together with the carbon to which they are attached represent a saturated C₅-C₆-ring which is optionally monosubstituted by methyl or methoxy and in which optionally one ring member is replaced by oxygen or sulphur, with the proviso that A then represents hydrogen,
G represents chlorine or nitro.

5. Use of a composition according to claim 1 for controlling insects and/or arachnids, which composition comprises compounds of the formula (I) in which
W represents hydrogen, chlorine, bromine, methyl, ethyl, methoxy or ethoxy,
X represents chlorine, bromine, methyl, ethyl, propyl, methoxy, ethoxy, trifluoromethyl, difluoromethoxy, trifluoromethoxy or cyano,
Y represents hydrogen, chlorine, bromine, methyl, trifluoromethyl or represents the radical 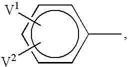
V¹ represents hydrogen, fluorine, chlorine, bromine, methyl, ethyl, tert-butyl, methoxy, trifluoromethyl or trifluoromethoxy,
V² represents hydrogen, fluorine, chlorine, methyl, methoxy or trifluoromethyl,
Z represents hydrogen, methyl, chlorine or bromine,
CDC represents one of the groups 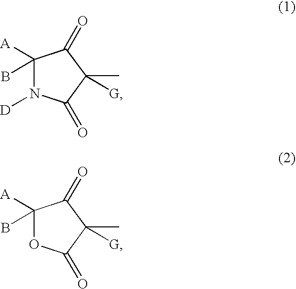
A represents hydrogen, represents C₁-C₄-alkyl or C₁-C₂-alkoxy-C₁-C₂-alkyl, each of which is optionally mono- to trisubstituted by fluorine, or represents C₃-C₆-cycloalkyl which is optionally monosubstituted by fluorine, methyl or methoxy,
B represents hydrogen, methyl or ethyl, or
A, B and the carbon atom to which they are attached represent saturated C₅-C₆-cycloalkyl in which optionally one ring member is replaced by oxygen and which is optionally monosubstituted by methyl, trifluoromethyl, methoxy, ethoxy, propoxy, butoxy or isobutoxy,
D represents hydrogen,
G represents chlorine.

6. Method for controlling insects and/or arachnids, characterized in that compositions as defined in claim 1 are allowed to act on insects and/or arachnids and/or their habitat.

7. Use of a composition according to claim 1 for controlling insects and/or arachnids, where the crop plant compatibility-improving compound is cloquintocet-mexyl, mefenpyr-diethyl, isoxadifen-ethyl, furilazole, dichlormid, fenclorim or the compound of the formula (IIe-5).
